(19) United States
(12) Patent Application Publication
(10) Pub. No.: US 2016/0301738 A1
(43) Pub. Date: Oct. 13, 2016

(54) SYSTEM AND METHOD FOR FILE DOWNLOADING DIGITAL MEDIA

(71) Applicant: IBOARD INCORPORATED, Pennington, NJ (US)

(72) Inventors: Christopher Gentile, Pennington, NJ (US); Adam Nemitoff, Glen Rock, NJ (US)

(21) Appl. No.: 15/155,143

(22) Filed: May 16, 2016

Related U.S. Application Data
(63) Continuation of application No. 12/711,975, filed on Feb. 24, 2010.

(51) Int. Cl. H04L 29/08

(52) U.S. Cl. CPC H04L 67/06; H04L 67/322

(57) ABSTRACT

A computer implementing a plurality of applications within an application framework is provided. The computer including non-transitory computer readable media, having stored thereon, computer executable process steps operable to control the computer to implement the plurality of computer applications, the plurality of applications including at least a digital media player (or other) application, a download manager application, and a third computer application, the download manager application coordinating and optimizing downloading to the digital media player (or other) application and the third computer application.

This application is a continuation of U.S. patent application Ser. No. 12/711,975, filed Feb. 24, 2010, the entire disclosure of which is hereby incorporated by reference. This application also expressly incorporates herein by reference, the entire originally filed contents of U.S. patent application Ser. No. 12/706,545, filed on Feb. 16, 2010.

### BACKGROUND

Music, and the media on which music is provided, has experienced a rapid evolution in the computer age. Digital audio files, such as MP3s, have become the norm for audio track distribution. A user may download one song from a band, several songs from across multiple albums, or may accumulate all of the songs in a released album. Selling a set of digital audio files, where the set includes the same tracks as a retail CD release, is already performed by several MP3 e-commerce sites. Often, they will price together all the MP3s that correspond to the tracks of an album release, and sometimes offer a discount for the album set as compared to the sum of each song individually. However, this is generally the extent of so-called digital albums in the prior art, i.e., a collective pricing together of individual audio files according to the songs found on a released album. Many musical artists and groups believe this is a detriment to the experience of their fans. Acknowledging the primary experience may be in the music itself, these artists believe much is lost by stripping these songs of the other aspects of a total album experience.

Evolving from computer systems capable of running only one application at a time, more and more multi-tasking operations are being built into modern devices. Operating systems are facilitating multiple applications executing at the same time, and applications are facilitating multiple threads during execution. Hardware systems are keeping pace with multi-processor systems, multi-core processors, and systems that simulate multi-core processors. Additionally, modern software and usage models have evolved from a local computer, to a local computer connected to a network, to distributed computing. Modern systems are becoming more dependent on the Internet to facilitate current usage patterns. With an expanding number of concurrently executing applications, each requiring use of an external communication network for various functions, significant strain is being placed on the fixed network connection of an individual device. This is true for relatively fast connections, such as high-speed consumer connections (e.g., DSL), and even more so for relatively slow connections, such as cellular Internet connections.

Some attempts at mitigating the effects of these bottlenecks have been implemented. Operating Systems will play a natural role in trying to facilitate multiple data transfers. Additionally, some “download managers” exist, which try to organize and optimize multiple downloads within one application, or even among several applications. However, these applications have serious limitations in both breadth of functionality, and depth of effectiveness, which example embodiments of the present application overcome with the novel features described herein.

### SUMMARY

Example embodiments of the present invention may include systems and methods for providing and downloading digital media, such as music files, video files. A centralized application resource manager may be provided to provide prioritized download of such files.

Example embodiments of the present invention may include a computer implementing a plurality of applications within an application framework, the computer including non-transitory computer readable media, having stored thereon, computer executable process steps operable to control the computer to implement the plurality of computer applications, the plurality of applications including at least a digital media player application, a download manager application, and a third computer application, the download manager application coordinating and optimizing downloading to the digital media player application and the third computer applications. The download manager application may perform steps including receiving from the digital media player application a first download request, the first download request being based on user input received by the digital media player application; receiving from the third computer application a second download request, the second download request being based on user input received by the third computer application, wherein the digital media player application and the third computer applications are independent of each other; prioritizing the first download request and the second download request, according to at least user priority input; downloading data associated with the download requests, according to the prioritization; upon completion of a data download, passing information regarding the downloaded data to whichever application passed the associated request to the application manager; upon completion of a data download, removing the completed download from the prioritization, and for all remaining data download requests: downloading data associated with the remaining data download requests, according to the prioritization.

Example embodiments of the present invention may include non-transitory computer readable media, having stored thereon, computer executable process steps operable to control a computer to execute a plurality of computer applications including at least a download manager application, a second computer application and a third computer application, the download manager application coordinating and optimizing downloading to the second and third computer applications. The download manager application performing steps including receiving from the second computer application a first download request, the first download request being based on user input received by the second computer application; receiving from the third computer application a second download request, the second download request being based on user input received by the third computer application, wherein the digital media player application and the third computer applications are independent of each other; prioritizing the first download request and the second download request, according to at least user priority input; downloading data associated with the download requests, according to the prioritization; upon completion of a data download, passing information regarding the downloaded data to whichever application passed the associated request to the application manager; upon completion of a data download, removing the completed download from the prioritization, and for all remaining data download requests: downloading data associated with the remaining data download requests, according to the prioritization.

The example may include computer readable media wherein the second computer application is a digital media album player application, and wherein the first download request comprises a request to download a package of digital media. It may further comprise non-transitory computer readable media having stored thereon computer executable process steps operable to a control a further computer to perform steps comprising generating a set of media titles and a set of other digital media related to one or more of the media titles; electronically transmitting the set of media titles to the computer for presentation to a user of the computer; receiving input at the further computer from the user via the computer indicating for which media titles from the set of media titles the user would like to receive a corresponding digital media file; transmitting from the further computer to the computer the package of digital media for download, including each digital media file indicated by the user; and wherein the package is configured to be executed by an album player with digital media presentation functions configured to present the set of media titles, the set of other digital media, and each digital media file included in the package.

Example embodiments of the present invention may include non-transitory computer readable media, having stored thereon, computer executable process steps operable to control a computer to execute a plurality of computer applications including at least a download manager application, a second computer application and a third computer application, wherein the second and the third computer applications are independent of each other and of the download manager application, and wherein the second application, the third application, and the download manager application can be independently shut down and independently run, the download manager application coordinating and optimizing downloading to the second and third computer applications. The download manager application may perform steps including receiving from the second computer application executing on the computer a first download request, the first download request being based on user input received by the second computer application; receiving from the third computer application executing on the computer a second download request, the second download request being based on user input received by the third computer application; prioritizing the first download request and the second download request; downloading data associated with the download requests from a network, according to the prioritization; upon completion of a data download from the network, determining if whichever application that requested the download is running, and if running passing information regarding the downloaded data to said whichever application for application-specific post download processing, and if the said whichever application is not running, performing said application-specific post download processing; upon completion of a data download from the network, removing the completed download from the prioritization, and for all remaining data download requests: downloading data associated with the remaining data download requests, according to the prioritization.

Example embodiments of the present invention may seek to remedy the limited artistic experience of a collection of digital audio files without context provided by the artist(s). Example embodiments may include a method of creating a digital media album that includes loading a template that defines a base structure and functionality of the album. This functionality may include at least one customization function and at least one media presentation function. The method may include defining a set of digital music pointers that each point to either a null value or a digital audio file. Further, the album may be configured to present the set of digital music pointers to an end user and the set of digital music pointers may be defined by a set of songs included on an associated traditional music album. The method may include associating digital media with the album, including digital audio, digital video, and digital still images, which may be presented via the media presentation function. The album may be configured to be downloaded by the end user, subsequent to being created, and may include functions configured to receive input from the end user modifying elements of the album or associating other digital media with the album.

The example method may also include generating a unique serial number to be associated with the album. The album may be created as a single data file from which individual digital audio files can be extracted. The album may maintain a common theme, wherein all digital media is related to the common theme. The common theme may include songs by a single artist or band, digital video performances by the single artist or band, digital photos by the single artist or band, album song lyrics, and information about the single artist or band. Further, each of the song pointers may illustrate whether there is associated digital audio with the pointer. The album may allow the end user to import media, including associating end user supplied digital audio with a pointer and adding user-created content. The album may include links to merchandise associated with the digital media and/or the relevant artist.

Another example embodiment of the present invention may include a digital storage medium that includes electronically stored data. The example storage medium may include media data configured to be played by a digital audio player, a digital video player, or a digital image presenter. The data may define or include a set of digital music pointers that each point to either a null value or a digital audio file. The music pointers may be defined or determined by a set of songs included on an associated traditional music album. The data may also include textual data associated with each active digital music pointer that presents the lyrics associated with digital audio data. The data may include structural data based on a framework and defining a base functionality of the electronically stored data. The data may include customized structural data configured to define presentation attributes of the structural data. The data may include customizable structural data configured to receive additional data from the end user, including digital media. Finally, the data may include configuration data that may define the interrelationships between different files of the media data.

Additionally, the example electronically stored data may be configured to be downloaded by an end user as a single file. After being downloaded, the single file may be “unpacked” into multiple files. The digital audio may be stored without Digital Right Management (DRM) protection, such that the digital audio may be used on any number of digital audio players (e.g., MP3 player). Other example data may be stored in encrypted form or include other DRM protection. The example data may be stored in partitions, and may include a “shrinking install,” where each partition may be removed from the example install data as it is installed. The example data may include a plurality of digital media files, where the presentation of each file has an associated function link for sending the file or a preview of the file to another user. The transmission could include e-mailing a link to a uniquely generated webpage. That webpage may include functions for forwarding the link, or forwarding a link to a modified webpage.

Another example embodiment of the present invention may include a method of providing a digital media album on a computer system that includes providing a package of digital media, including a set of song titles and a set of other digital media related to one or more of the song titles. The example method may present the set of song titles to a user. The example method may then receive input from the user indicating for which songs from the set of song titles the user would like to receive a corresponding digital audio file. Next, the example method may transmit to the user the package of digital media, including a digital audio file for each song indicated by the user. In the example method the package may be configured to be executed by an album player with digital media presentation functions configured to present the set of song titles, the set of other digital media, and each digital audio file included in the package.

The example method may also be configured such that the set of song titles is substantially defined by a set of song titles found on a traditional album. The example set of digital media may include media such as digital audio, digital video, and digital still images. The example album may have an associated cost, and the example method may present the cost to the user, wherein full access to the album may be conditioned on payment of the cost. One example method for this is to authorize full access upon the successful download of an access key. The example method may set the cost as a function of the user input indicating which songs from the set of song titles the user would like to receive a corresponding digital audio file for. The example cost function may include a base cost for the set of other digital media plus a marginal cost for each corresponding digital audio file included in the package. The individual audio files may have their respective marginal cost set individually, e.g., they may have different costs, one or several price-points, or uniform costs. The example album provided to the end user may have a fixed set of initial content (e.g., the media included with the specified digital audio files), and the user may be able to add content via import and/or supplemental purchase. For example, the user may associate a digital audio file with a song title from the set of song titles.

Example embodiments of the present invention may include systems and methods for providing a central application manager. An example embodiment may include a computer implemented method for managing computer applications. The example method may receive, from a first computer application a first download request, the first download request being based on user input received by the first computer application. The example method may receive from a second computer application a second download request. The second download request may be based on user input received by the second computer application. Also, the first and the second computer applications may be independent of each other. The example method may prioritize the first download request and the second download request, according to at least user priority input. The example method may download data associated with the download requests, according to the prioritization. Also, upon completion of a data download, the example method may pass information regarding the downloaded data to whichever application passed the associated request to the application manager. Finally, upon completion of a data download, the example method may remove the completed download from the prioritization queue, and for all remaining data download requests, the example method may continue downloading data associated with the remaining data download requests, according to the prioritization.

Further, in an example embodiment of the present invention, the functions of receiving and passing may be performed between the application manager and at least a third application and third download request. The prioritization may be based upon input received by the application manager, from a user. The example method may record performance metrics of the application manager. The application manager may also be configured to receive application updates from an update server, and the application manager may be configured to pass the updates along to whichever application of a plurality of applications indicated by a particular update. Additionally, individual connected applications may pass along a request for an update, and the application manager may download and pass back the update.

In another example embodiment of the present invention, the application manager may receive a plug-in from some or all of the applications under management. This plug-in may perform a sub-set of functions provided by the individual applications, and the application manager may perform those functions upon completion of a data transfer. Alternatively, the application manager may pass the completed data to the requesting application to perform the functions, and only perform them at the manager level when the application is offline.

Additionally, example embodiments of the present invention may include components for providing a user interface. Further, a second, sub-set interface may be provided with a sub-set of functions. This sub-set interface may provide any number of features, including “pause all” functions for pausing data transmissions. The sub-set interface may also notify the user of new messages received and file transmission status.

### BRIEF DESCRIPTION OF THE DRAWINGS

FIG. 1A to 1G illustrate example digital multimedia album interfaces, according to one example embodiment of the present invention.

FIG. 2A illustrates an example single-file download of an example digital album, according to one example embodiment of the present invention.

FIG. 2B illustrates an example single-file download “unpacked” for installation, according to one example embodiment of the present invention.

FIG. 3 illustrates an example digital album data-structure, according to one example embodiment of the present invention.

FIG. 4 illustrates an example procedure, according to one example embodiment of the present invention.

FIG. 5 illustrates an example construction routine, according to one example embodiment of the present invention.

FIG. 6 illustrates an example method for providing an album, according to one example embodiment of the present invention.

FIG. 7 illustrates another example method for providing an album, according to one example embodiment of the present invention.

FIG. 8 depicts a block diagram of how the different software modules relate to each other, according to an example embodiment of the present invention.

FIG. 9 depicts an example download queue prioritization procedure, according to an example embodiment of the present invention.

FIG. 10 depicts a block diagram of an example device, according to an example embodiment of the present invention.

FIG. 11 depicts an example of how the application/manager connection process occurs in one example embodiment of the present invention.

FIG. 12 depicts an example procedure of connecting/initializing a new application, according to an example embodiment of the present invention.

FIG. 13 depicts an example procedure of receiving, queuing, facilitating, processing, and prioritizing transfer requests, according to an example embodiment of the present invention.

FIGS. 14A and 14B depict example graphical layouts of a user interface, according to example embodiments of the present invention.

FIGS. 15A and 15B depict example graphical layouts of a sub-set user interface, according to example embodiments of the present invention.

### DETAILED DESCRIPTION OF EXAMPLE EMBODIMENTS

### A. Downloadable Digital Media Albums

Example embodiments of the present invention may include a digital multimedia album.

Example embodiments may include a user interface for the construction, customization/modification, and presentation of one or more digital albums. Further, example embodiments may include a data structure for storing the various components of a digital album, as discussed below.

The digital album may consist of a customizable multi-media experience, consistently themed around one artist, group, or other similar entity. Once installed, a digital album may provide the user an interface with several forms of related and user-added content. Initially, the digital album may include digital audio files (e.g., MP3s). The set of digital audio files may be structured to resemble or replicate the set of digital audio tracks included on an “album” (e.g., CD) at a retail location.

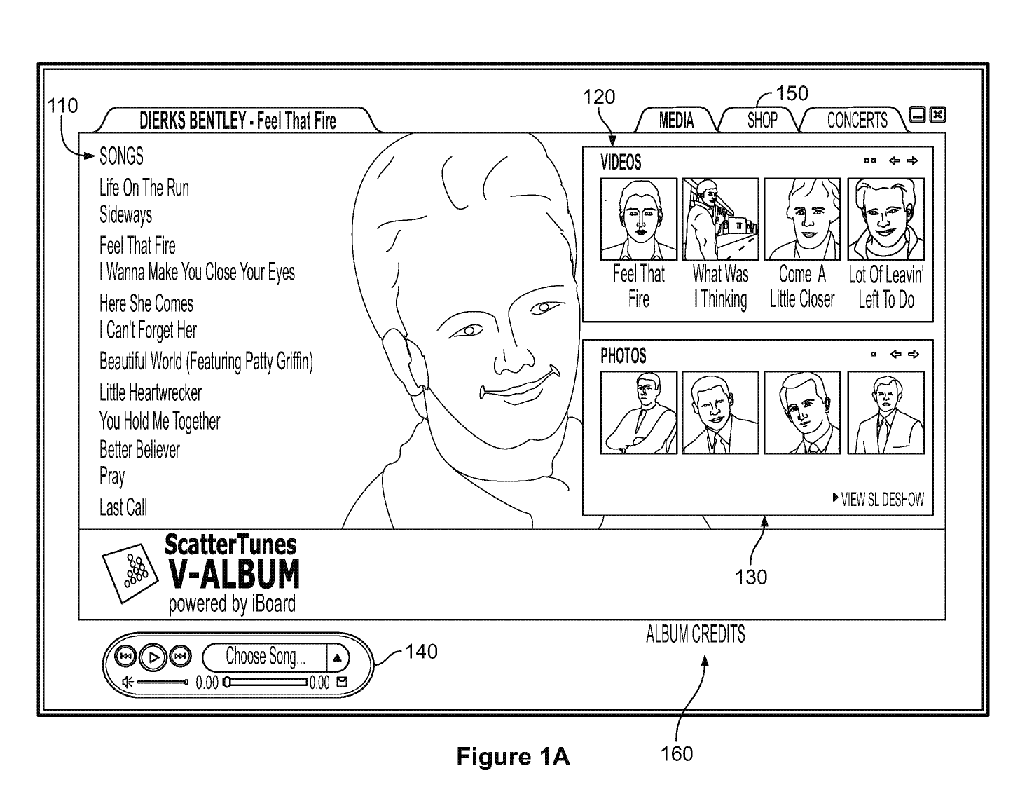

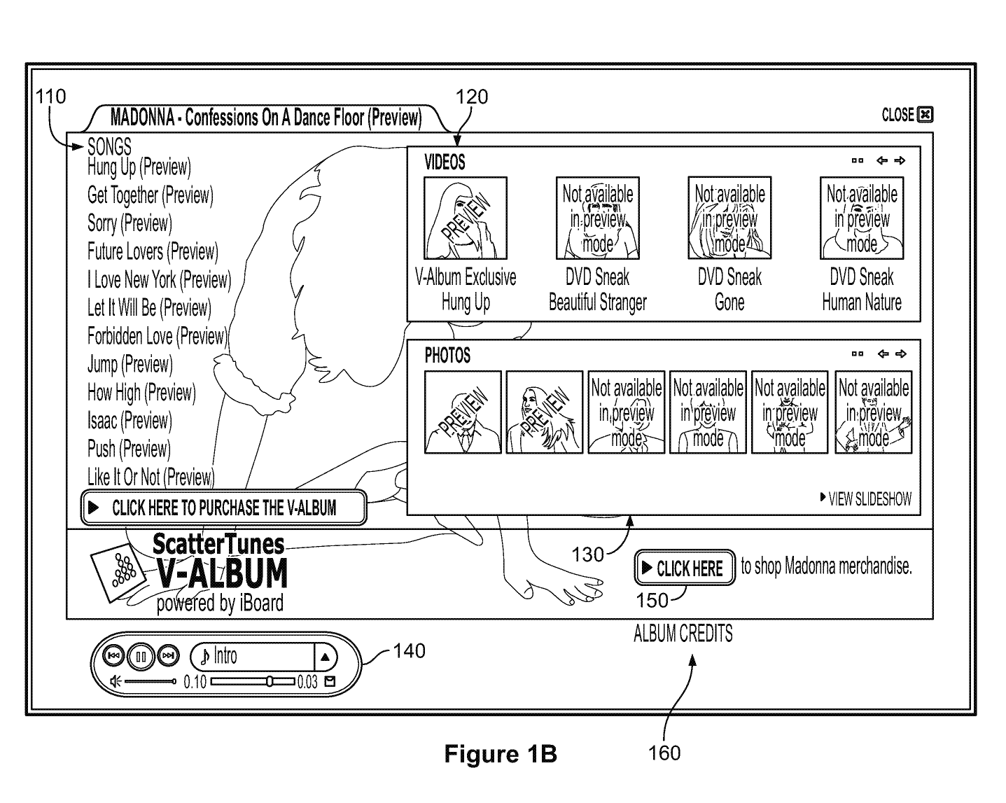

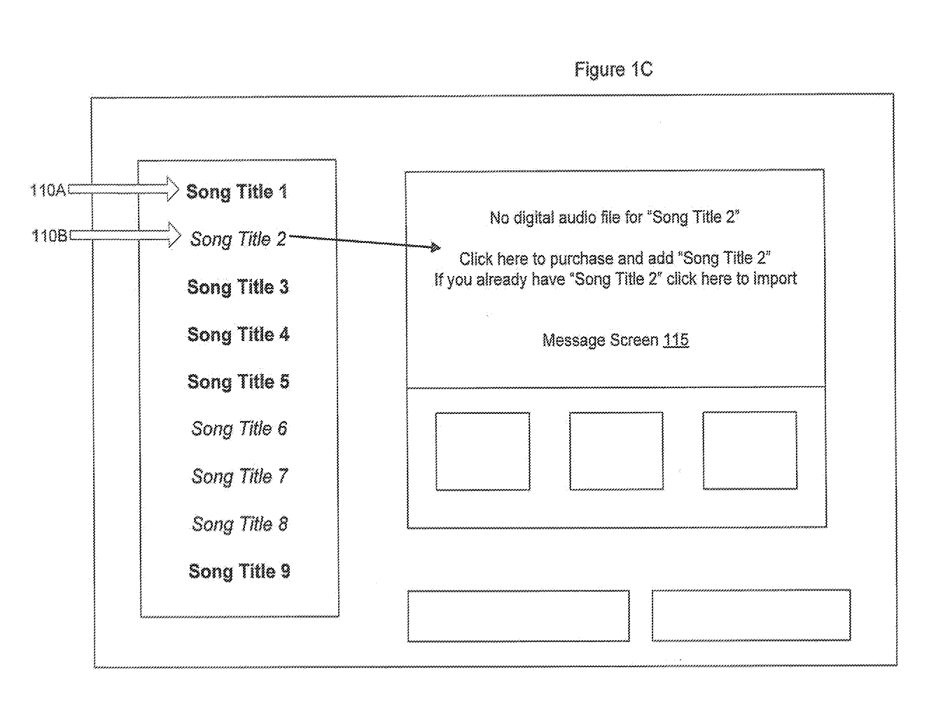

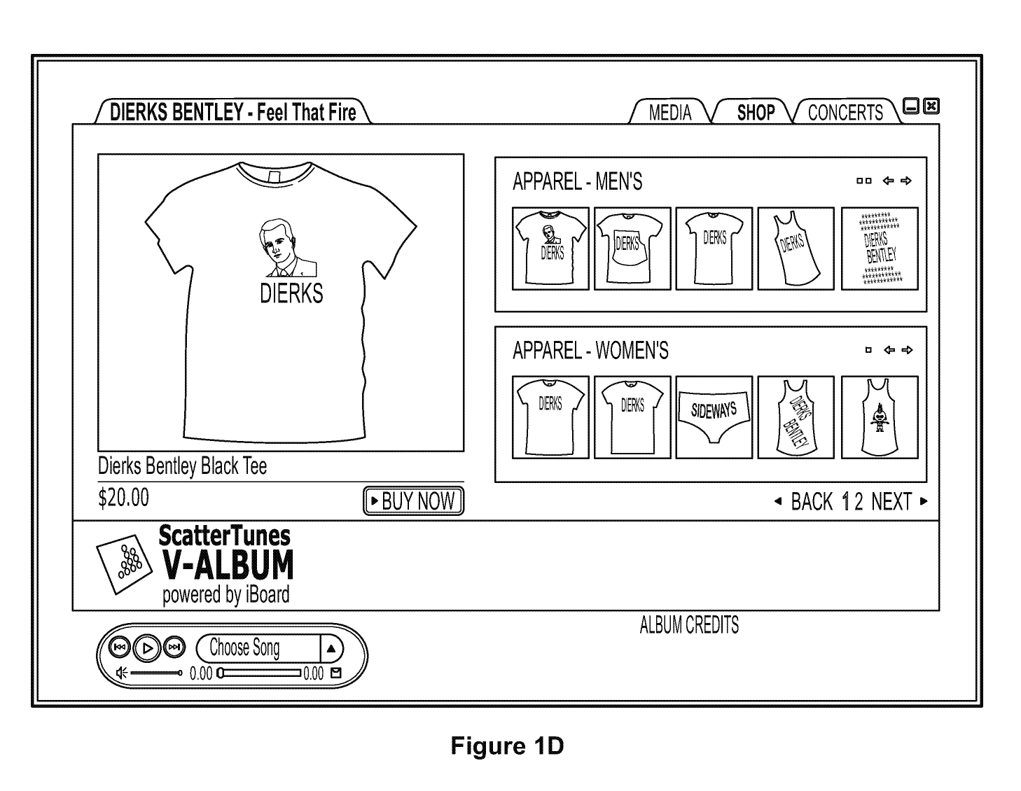

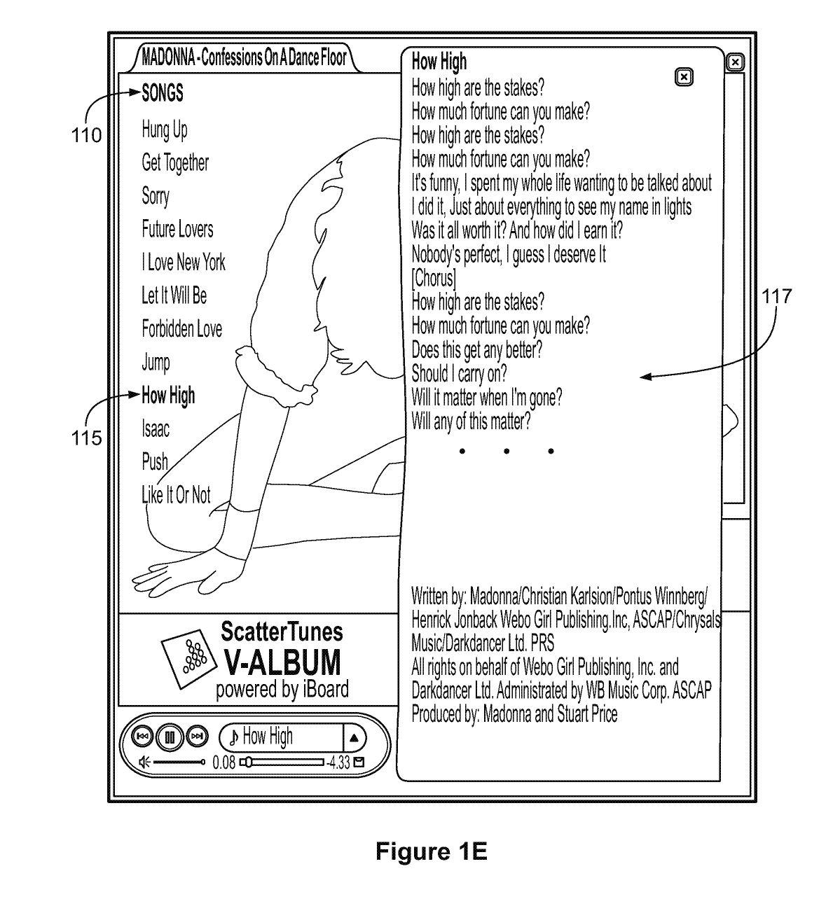

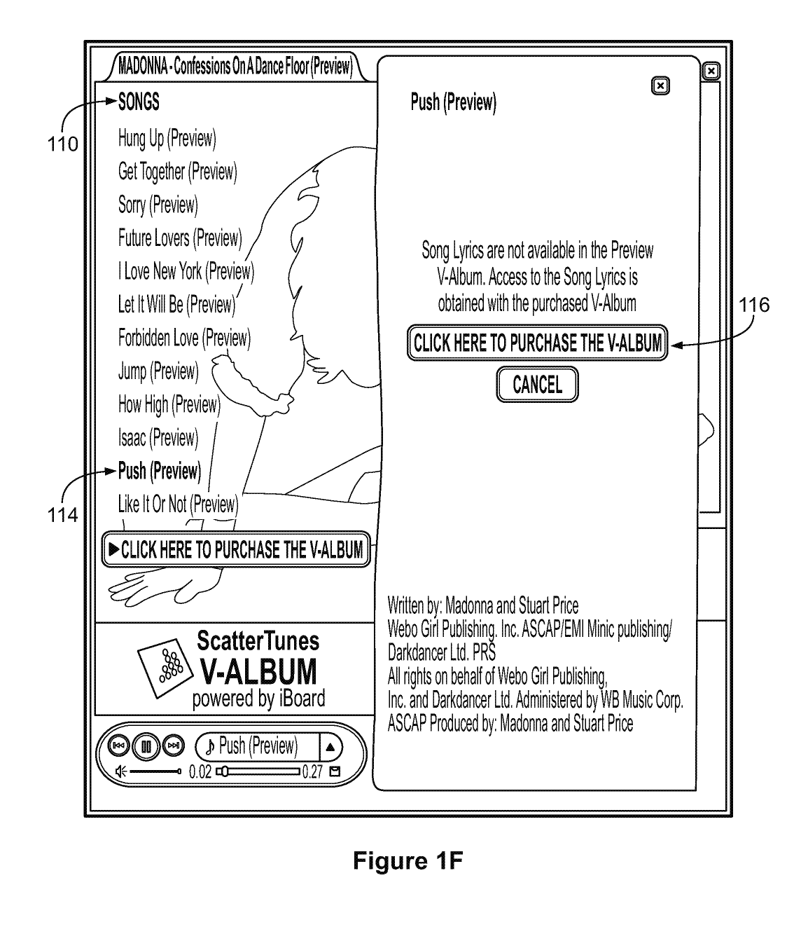

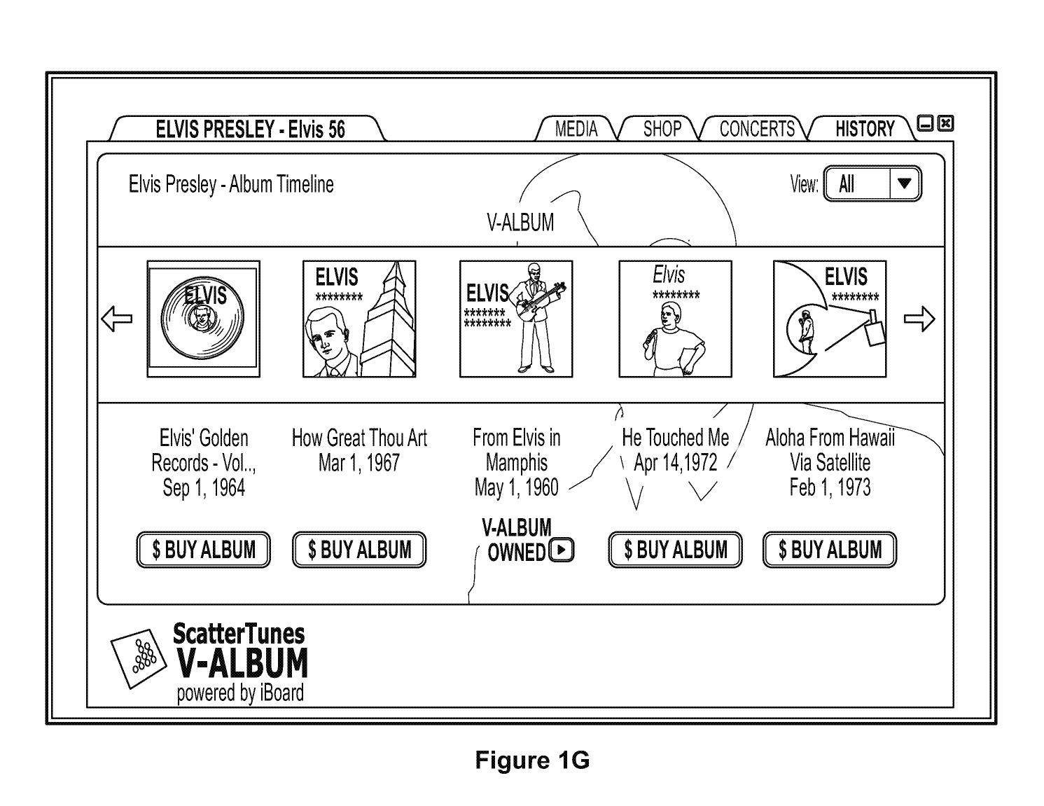

FIGS. 1A and 1B each illustrate an example embodiment of an installed digital album interface. Element 110 includes a list of song titles, and may contain pointers to digital audio files associated with those song titles. As mentioned, the list of song titles may replicate or resemble (e.g., with more or fewer bonus tracks, etc.) the set of tracks available on a retail album. Element 140 illustrates a multi-media player. In the case of songs 110, the player may play the associated digital audio file, and provide controls for playback. Element 120 illustrates a video library section. In one example embodiment, the video files may be stored with digital rights management (DRM) protection. The videos may include any number of album/artist/band-related material. For example, music videos may be associated with the digital album songs, interviews of the band members or associated persons, and/or videos of live performances by the band. Further, in addition to professional content, users may import other related content. For example, a user may have made a personal video while at a performance, a karaoke session, or other “home movie” related to the digital album content. This material may also be stored in the video library and presented in element 120. The user-added videos may be stored free of DRM protection, or may have it added at the request of the user. One example reason for this may be for certain digital albums that allow for album copies to be made, the user may want to protect the added content, before sending a copy to a friend.

The user import function may serve other purposes as well. The digital album may be available for purchase independent of the digital audio files. Thus, if a user already had all of the MP3s that comprise an album, that user could purchase only the digital album, or rather a digital album with no included digital audio files. The songs list 110 may still have all of the digital album track titles, but may indicate all or some are missing playable data. The user may then associate any digital audio file with the song title link (e.g., a previously purchased copy of the song). In this way, digital albums may be sold at varying price points, with all, some, or none of the actual digital audio files associated with the album set of titles. For example, FIG. 1C illustrates an album a user may have downloaded where only the first, third, fourth, fifth, and ninth songs are included (e.g., 110A), and the second, sixth, seventh, and eighth song titles have no associated digital audio file (e.g., 110B). The user may have purchased this album at a discount to the full album. Additionally, when the user tries to play a missing song (e.g., 110B), a message 115 may alert the user there is no associated data. The message 115 may then prompt the user to purchase the song, or import an existing file.

Additional example album elements may include element 130, which illustrates a collection of still images related to the digital album theme. This may include images of the band, artist(s), logos, graphics, cover art, band art, performance images, or any number of other still images. Similar to the video, users may also import their own home images, e.g., pictures taken while at a performance or convention. A user may have dressed as one of the artists for a party or holiday (e.g., Halloween), and want to include with the digital album images of him or her in costume. Of course, in example embodiments where user-created content is allowed to be imported into the digital album, it might not be possible to ensure the content fits with the theme of the digital album. However, example embodiments may limit the default content, or original owner updated content to theme specific content. For this reason, other example embodiments may have separate sections for user content and/or designate them in a separate manner, in order to distinguish the content that is known to fit with the digital album theme.

Element 150 illustrates a link to a merchandising section. This section may be presented in the same interface, replace the interface shown in FIGS. 1A and 1B, or launch a new interface (e.g., a web-browser). The digital album, (e.g., the interface illustrated in FIGS. 1A and 1B,) may wholly contain the related merchandise that is available for purchase, may present “stubs” of merchandise available on other sites and link to those sites, or may simply transport the user to a site known to sell related merchandise. FIG. 1D illustrates one example embodiment where the merchandise is presented within the interface. The items illustrated in FIG. 1C may bring the user to more information and checkout functions within the interface, or launch external e-commerce partner sites to complete the purchase of selected items.

Other features, such as a listing of album credits (e.g., 160) may also be available. Additionally, the digital album may contain customary navigation and menu options, such as the arrow navigation buttons in the video 120 and photo 130 areas. The digital album may include any number of other relevant features. For example, the lyrics of each song may be available to the user, and may automatically display when a song is selected and/or played. An example of this is FIG. 1E, for which the song 115 “How High” is selected, and the associated lyrics 117 are presented to the user. Also, an example digital album interface may indicate where in the textual lyrics the digital audio file is currently playing, e.g., similar to a karaoke or “sing along” system, i.e., scrolling textual lyrics. Other features may be available to the user during playback as well. For example, the user may be able to start a slide show of the included images that plays during song playback. Another example embodiment may have a slideshow synchronize with the playback audio, e.g., rotating through images according to the tempo of the currently playing digital audio file.

Digital albums may also include text-based features, beyond the lyric text associated with the song files. For example, short biographies of band members or artists associated with the particular digital album may be included, and may be associated with images of the same. News articles, press releases, and band-member-authored “statements,” e.g., open-letters to fans, etc., may also be included as text media within the digital album. Additionally, real-time text may be included. For example, a solo artist or band member may have a blog, micro-blog (e.g., “Twitter”), or other frequently updated information feed, which may be included in the digital album, via automatic updates. The digital album may include utilities and functions to present web-cam or other web-served video/audio interviews with band members, through streaming media protocols.

Digital albums may also come in “preview” form, e.g., a limited version designed to illustrate the product and encourage purchase of the actual digital album. A preview album may include any number of limiting features. For example, songs and video may be limited to the first several (e.g., 30) seconds of playback, images may be of reduced resolution, user data import may be limited to some number (e.g., 2) of items per section, and lyrics may be limited to a few lines or totally blocked (e.g., as illustrated in FIG. 1F). Certain aspects of the preview album may be fully functioning, e.g., the merchandising section. The preview album may include a function to purchase the full digital album. The preview album may include a source identifier, which may be used to issue commissions for associated preview albums that are converted via purchase into full digital albums.

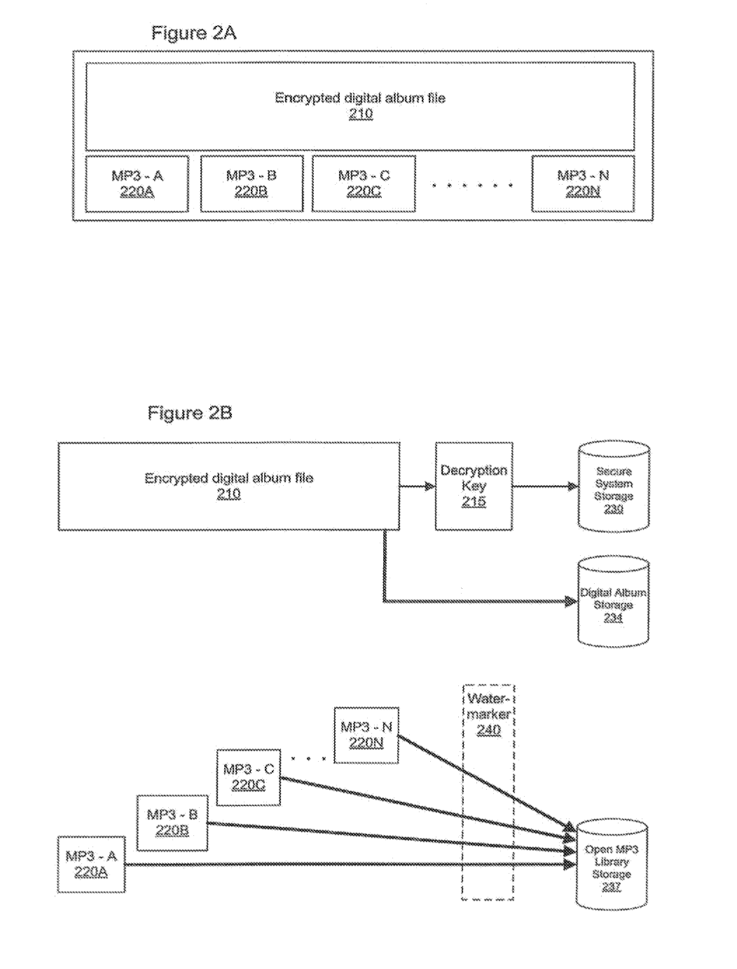

Digital albums may be delivered via a network server. Digital albums may be sold at retail locations, but this type of sale may be for a product code used to download the digital album without further purchase. Alternatively, the actual install data may be provided at the retail location. However, example embodiments may require authentication with a license server, and in this case, regardless of the origin of the install data, a network connection may be required. The digital album, as discussed above, may be a collection of different components (e.g., audio files, video files, image file, etc.). However, to minimize the load on the distribution server(s), and thus minimize the cost of product distribution, the digital album may download as a single file. For example, FIG. 2A illustrates a single file download, where an encrypted digital album file 210 is “wrapped up” with individual unencrypted MP3 files A to N. In alternative embodiments, the digital album may be distributed in more than one data packages, or from more than one distribution source.

Digital album files, e.g., FIG. 2A, may run on a digital album player, which may provide the common logic and utilities (e.g., multi-media player(s)) for one or more digital albums. Alternatively, each digital album may contain its own logic, using frameworks already on the installing system (e.g., Java plug-ins, media APIs, etc.). FIG. 2B illustrates an example deconstructing of the single digital album download file. The single digital album download file may consist of two main parts. First, a set of unencrypted digital audio files, e.g., MP3A to MP3N. Second, an encrypted file, set of files, or other data structure, which may contain all of the other digital album content, e.g., videos, images, lyrics, text, etc. This file may be referred to as the “V-Wrap” and include all of the digital content and data for the V-Album, other than the MP3 files. The V-Wrap may however, include song previews for any song associated with the V-Album, but for which there is no associated digital audio file of the complete song. In alternative embodiments, the digital audio files may be encrypted as well, or contain any number of DRM protection. However, common industry practice has evolved into allowing MP3s to be unencrypted and free of DRM protections. Likewise, the digital album data 210 (e.g., V-Wrap) may be unencrypted, or partially unencrypted.

In the example embodiment illustrated in FIG. 2B, the digital album is encrypted and contains a decryption key 215. Decryption key 215 may be removed from the digital album install data, and stored in a secure directory of the installation device. This secure directory may be provided by the device operating system, or generated by the digital album program. However, most device operating systems provide one or more secure directories for storing such files as a decryption key. The remaining data from the digital album data 210 may be installed in one or more regular directories of the main storage memory. These one or more digital album storage areas 234, may be separate or part of the digital audio library storage memory 237. In the example embodiment illustrated in FIG. 2B, the MP3s are stored in a separate memory location, to provide easy access to the user for other applications (e.g., inclusion in an MP3 player not capable of having the digital album portions installed).

In addition to “unpacking” the digital audio files 220A to 220N, and storing them in memory, whether temporary or persistent memory, the digital album application may perform certain post-download processing on the digital audio files, or any number of other data pieces from the digital album file 210. Here, the digital album program (e.g., the digital album application responsible for presenting digital albums based on the download/install content) may post-process the MP3s by adding a watermark with “water-marker” 240. This watermark could include any number of things, and may include identification (ID) unique to the digital album player installed on this device, the purchase location, IP address, date, and/or time. This way, the MP3, or other digital audio file, may remain free of DRM protection, and thus remain usably flexible, but still have a source identifier associated with the originally distributed copy.

In one example embodiment, the install process illustrated in FIGS. 2A and 2B also includes a feature of a “shrinking” install. During most install processes, an install file is executed to fully install a target program or data, and only upon completion is the entire install file then removed or marked for eventual overwrite. Here, however, because the single install file may contain very large media files, the total file (e.g., FIG. 2A) may be quite large. For example, a single four-minute music video in true high definition (HD) and native (e.g., minimal) compression, may consume over three gigabytes of disk space. Since digital albums may contain many songs and other videos, a complete set of content may include disk sizes around a hundred gigabytes. Of course this is only one example embodiment, and stronger compression, lower definition, or other space saving measures may be used. Regardless, a particular install may be quite large for some systems and users. The shrinking install allows for the amount of space needed, above the sum total size of the install file, to be no larger than the largest piece. In this way, the installer may unpack a video file, install that file in the system, and then delete that portion of the install file, thus “shrinking” the install file as pieces are no longer needed.

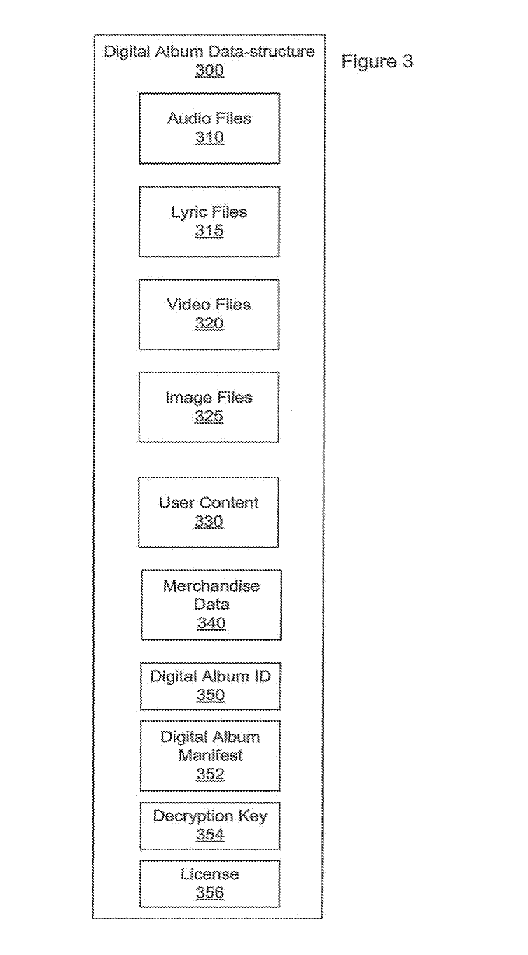

FIG. 3 illustrates an example embodiment of a digital album data structure, including components previously discussed. The example data structure may include audio files 310, (e.g., MP3s), lyric files 315, video files 320, image files 325, user content 330, and merchandise data 340. Additionally, each digital album may include a unique digital album ID 350. This ID may be used to uniquely identify every instance of a paid-for download, but may not necessarily be unique for every copy. For example, a digital album may be configured to be freely copied by the original purchaser. Thus, each instance or copy of this originally purchased digital album may share the digital album ID 350. Additionally, each digital album may include a manifest file 352. This file may be, e.g., a configuration file, instructing the digital album program how each of the many original and added digital album content components interrelate to each other, and how they should be presented.

Each digital album may include a decryption key 354, because each digital album components, other than the digital audio files, may be stored in encrypted form. In another example embodiment, the decryption key may be obtained from a central license server in response to a license request. This way, the decryption key may only be associated with active digital albums and not with unlicensed albums, e.g., those with no remaining licenses. Further, the digital album program may load the decryption key 354 into memory, and perform “just-in-time decryption.” This may enable the digital album to never write an unencrypted version of a media file to the hard-drive, and preserve the protection integrity of the components. Each digital album may have a license 356. This may include any number of things related to the legal status of a particular digital album, and may also include an indication of how many additional times the digital album may be installed. Some digital albums may have unlimited installs, some may have unlimited installs on a particular machine or location, and some may have a fixed number of installs. This feature may be customizable by the original content owner, according to their distribution needs. The client license may be associated with a master license stored at a central license server. The client license may specify certain limits and/or abilities, with the full license data stored in the master license.

In an example embodiment, content themes are not limited to newly released albums. For example, a V-Album store may present legacy albums of older (e.g., classic) album sets. For example, an artist with some number of previously issued albums, starting many years ago and representing a career of works, may have one or more of those previously released albums converted to a V-Album, for sale on the system. FIG. 1G illustrates one such example. Here, several Elvis albums are presented in chronological order. Some may indicate a V-Album for sale, and where an album has no associated V-Album, the system may provide alternative purchasing options (e.g., re-mastered CD offering, discounted MP3 set, etc.). In addition to including materials that were originally associated with the historic albums (e.g., the songs (MP3), lyrics, art, etc.), other V-Album content may be associated with the various albums. For example, several videos of the artist may be collected and associated with the V-Album closest in time with the date of the video. So each video created between the original release dates of two particular albums, may be associated with the V-Album based on the earlier of the two. In this way, a history tab, presenting the life-work of an artist may show an artistic evolution over the several years of that artist's career, by associating content with V-Albums in a specific order. Additionally, some content may be associated with every V-Album (e.g., currently available merchandise).

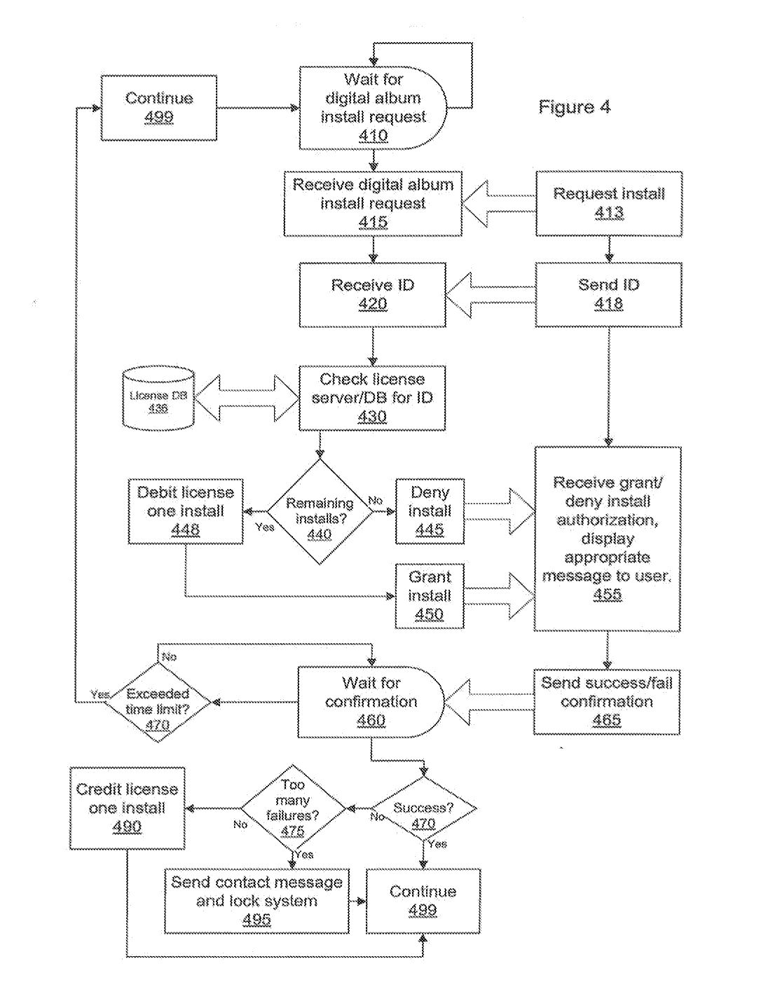

FIG. 4 illustrates one example embodiment of how the install authorization process may work. FIG. 4 illustrates both the installing device on the right side, and the authorizing system on the left side. Starting at 410, the example procedure authorizing system may wait for a new digital album install request. When a digital album is going to be installed on a device, the digital album application on that device may request an install authorization at 413, which may be received at 415. Next, at 418, the device may send the unique digital album ID (e.g., 350), which may be received at 420. Using the unique digital album ID, the authorization system may check a license server and database, to determine if allowed installs remain. This is only one example embodiment for illustrative purposes; other licensing and authorization schemes are also possible. In this example embodiment, an original content owner may have authorized some number of installs for a purchase of a particular digital album. If there are no remaining installs at 440, the authorization system may return a deny message at 445. If there are remaining installs, the authorization system may return a grant message at 450, after debiting the license one install credit at 448. These messages may be received by the installing device at 455. If a deny message is received, the digital album application may prompt the user to place a purchase for the digital album at that time. If a grant message is received, the digital album application may continue with the installation.

The authorization system may wait for a success/fail confirmation from the installation program at 460. However, if a time limit is exceeded, the authorization system may return to normal operations at 499, without returning the installation credit, as a security measure. An example embodiment may also log the event, so that a customer may call customer service to try and receive the credit back. If a success message is timely received, then the authorization system may again continue normal operation at 499. However, if a failure message is received, the authorization system may check to make sure the install has not repeatedly failed in some timeframe at 475. If it has not, the license may have one authorized install credited back at 490, and then continue at 499. If there have been too many failed attempts in some time frame, the authorization system may send, at 495, an exception that the digital album program may present to the user with an instruction to call customer service to resolve the issue. Additionally, at 495, the system may lock that digital album ID or license from future install attempts until unlocked by a customer service representative. Subsequently, again, the authorization system may return to normal operation at 499. The example procedure illustrated in FIG. 4, is only one example embodiment, and illustrated as a concurrent and linear execution. It may be noted however, that while the steps subsequent to 410 are executing to confirm an authorized install, the example procedure may continually execute 410 for other installation requests.

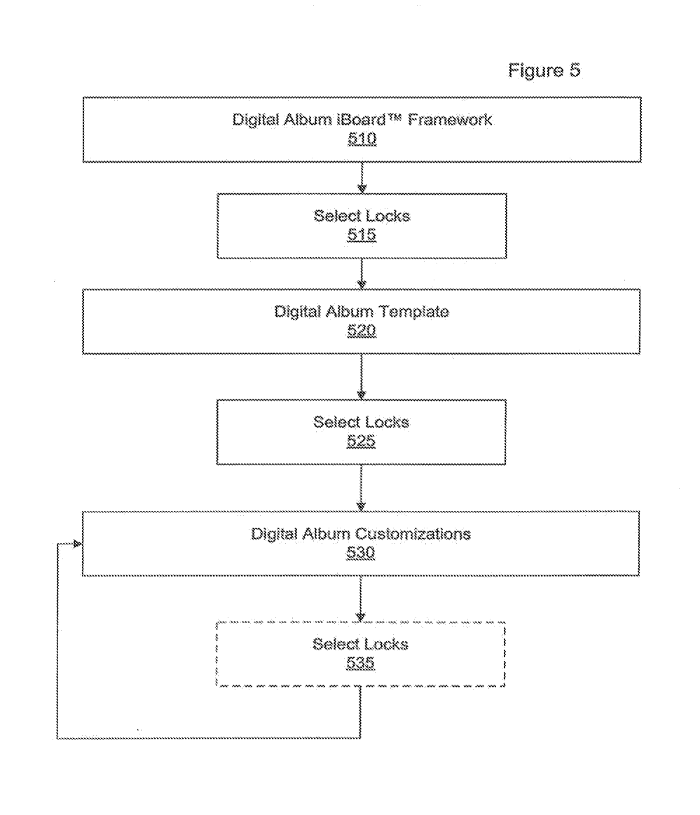

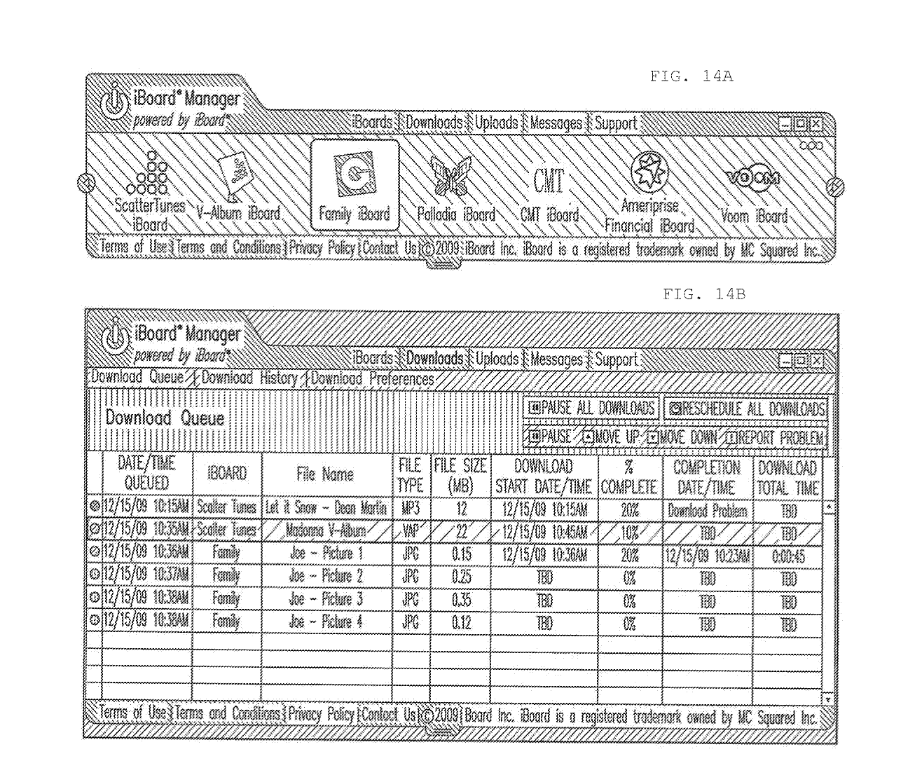

The actual structure of a digital album may be based on a progression of varying foundations and/or templates. As illustrated in FIG. 5, the digital album may begin by being built on a framework, such as an iBoard™ framework. This iBoard™ framework 510 may be a pre-established application creation framework, used to construct any number of wholly or partially independent applications. The example display of FIG. 14A illustrates the “iBoards” feature as a collection of the installed individual applications for the user to select. In any event, in the process of building a base digital album template 520, certain framework features and options may be left customizable or locked down at 515 by the designer of a particular version of the application. Having created a particular digital album template 520, a digital album designer may build a particular digital album using that template. At this stage, the designer may be making a retail design based on the template, for a specific artist or band. At 525, the designer may also have an opportunity to select what template features will be locked down and permanent, and which features will be customizable by the user. Once the digital album is set by 525, the retail customer may receive it via purchase, and may be able to customize the digital album according to what was left customizable at 525. Optionally, the user may also be able to lock down certain customizations, especially if the user is allowed to transmit customizable copies to other people. For example, the user may lock a personal video they added to the digital album, if they do not want that video to be extracted or modified, etc.

User customizations at 530 may include a number of modifications. For example, as was previously discussed, the user may add various pieces of content, such as videos, images, etc. Also, a user may be able to adjust the layout of the digital album, and arrange where certain features are located within the interface. The user may be able to select user settings, from playback volume to video compression style. The user may be able to add services, such as a blog-feed module, and may be able to remove services, such as the video module (e.g., 120).

Users may be provided one or more base templates and a V-Album creation application. The V-Album creation application may be sold, or alternatively may be free or free to try. One embodiment may include a free V-Album creation application that may watermark any created V-Album. A watermark may generally be any tool that allows for use of the application while obstructing the final product of the free application version. For example, included art and videos may have a semi-opaque word printed across the visuals, while audio may include a half-volume message once per time period (e.g., “this audio track belongs to a demo V-Album creation, please register your creation software at . . . ”). This way, rising artists and amateur performers may have a tool for showcasing their collection of works in a context relevant format. Once a user chooses to purchase the distribution package for the created V-Album, the various watermarks and/or DRM protections may be removed from final products created by the user of that application. A user may also be able to upload creations to a distribution server, which may automatically create a customizable webpage for that user-created v-Album upload.

The user may also be able to purchase distribution codes for the created V-Album. In one example embodiment, only user-created V-Albums with purchased distributions will have the watermark removed. For example, a user may be offered an initial V-Album package that includes a template for created a V-Album, and a number of distribution codes. After the user uploads a finalized product, that user may send a distribution code to a friend, family member, or potential label/booking agent. The recipient may then download a copy of this user-created V-Album, which may include a portfolio of the user's work. Additional distribution codes may be purchased for some amount of money, or alternatively, the user may set the customizable web page for their V-Album to charge the downloader for the distribution code. The user may be able to set the price of a download, in order to profit from any payment beyond the administrator's commission/fee. Alternatively, the base fee may include a user commission, which the user may choose to waive or collect.

In alternative example embodiments, a user may not be charged for any of these services, but may be provided with them for free, or partially for free. A user-created V-Album may include an artist influences section, where the V-Album creator(s) may indicate which artists, albums, songs, or such similar item influenced the music presented in that V-Album. This list of influences may then present opportunities to purchase the V-Albums or MP3s of those influencing artists. In this scenario, user-created V-Albums may be free of charge in order to facilitate greater advertising of the established artist(s)' V-Albums. The system may also include a store for user-created V-Albums, which may accept any submission, or may screen for specific criteria (e.g., marketability). The user-created V-Album templates and creation software may include targeted advertising as an alternative or in addition to charging for use of the creation tool and templates. For example, a local photographer may advertise a discount rate for a professional cover-photo shoot, etc.

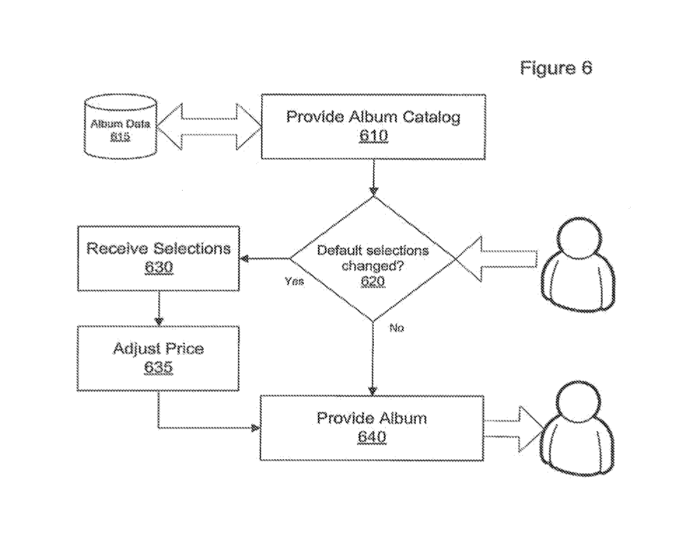

User customizations of retail V-Albums may also include finalizing a partial album. For example, FIG. 6 illustrates an example method for providing a partial album. At 610, the example method may access album data 615 and provide one or more albums available for download. As part of this example process, the user may be provided an opportunity to de-select certain content. For example, one or more of the associated digital audio files. At 630, the example method may receive these selections from the user and at 635 the example method may adjust the price accordingly. At 640, the example method may provide the album according to the user selections made. In this way, the example method may provide the user with only the content the user wants, and that content may be priced accordingly. Different albums may have different price structures, and those price structures may be fully customizable by the content owner or representative. One example structure may be to assign a cost of the album alone, e.g. $9.99. Then assign a cost for each digital audio file, which may conform to industry standards, e.g., $0.99. Accordingly, the cost of a full twelve song album may be $21.87. If a user were to deselect a song, the cost may be $0.99 less. Of course, an album may be set up to provide less of a discount than the full song cost of $0.99, and discounts may be available for quantity purchases, e.g., the whole set of files. Additionally, each song may have a different price. For example, more popular songs that are downloaded frequently may cost $1.49, and less popular songs may be discounted, e.g., $0.49, to encourage purchasing these files as well.

In addition to purchasing partial albums, as described above, partial albums may be completed with the user import functions. This way, preexisting files may be associated with song titles that have no associated digital audio file. This is only one example embodiment, and albums may be configured to only come with a complete set of digital audio files and at the full price. Content owners or other interested parties may desire to configure their albums with a locked set of digital audio files having no option for the customization of the song title/digital audio file portion of the album.

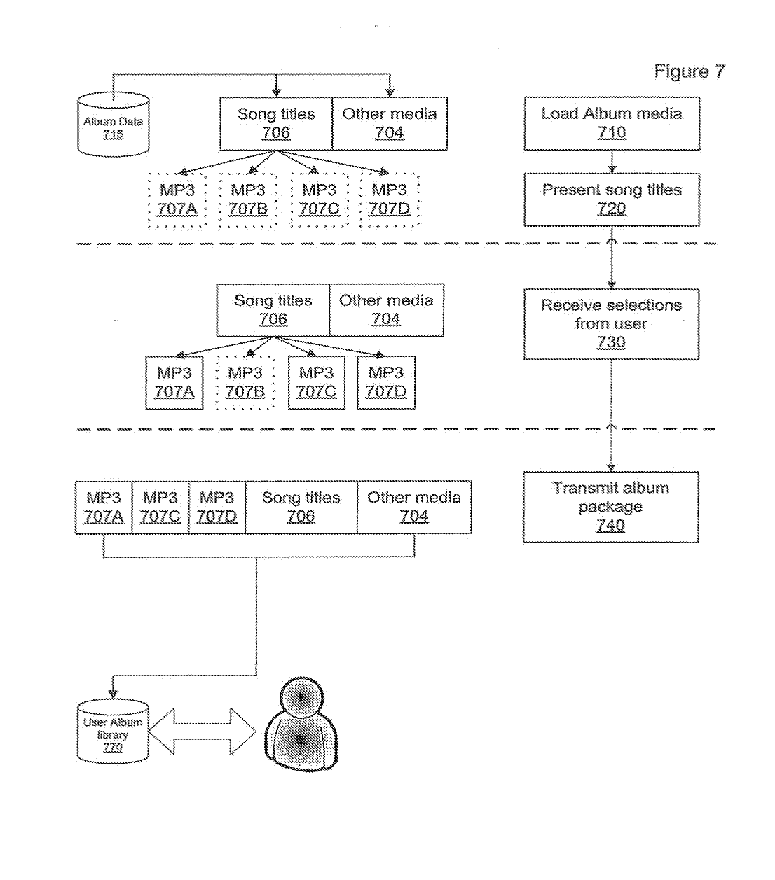

FIG. 7 illustrates another example embodiment of the present invention. An album server method may initially load album media at 710. For example, data may be loaded from a database 715, including a list of associated songs 706 (e.g., with a pointer associating a digital audio file for each song), and also including other digital media 704 that may form part of the Album. The example method may present the song titles 706 defined by a certain album at 720. Next, at 730, the example method may receive selections for a user indicating which digital audio files the user would like included in the album package, and which may be left off. Here, the digital audio files are illustrated as MP3s, and the user has selected files for 707A, C, and D. MP3 707B was not selected by the user. Once the customizable contents of the initial download are fixed, the example method may transmit the album package to the user at 740. The package may be stored and/or installed on the user system (e.g., as illustrated in FIG. 2B). Example embodiments may also require payment for the transmission, or payment may be made at a later time (e.g., at the license acquisition time illustrated in FIG. 4).

Other features are also possible in example embodiments. For example, the digital album may provide a postcard advertising/sharing system, where a digital album user may share any aspect of their digital album with another user. For example, the digital album may include a share link with every file associated with the digital album, such that when a user clicks the share link for one of the videos, a unique postcard is created for that video as it relates to that digital album, and an email is sent to a specified recipient(s). The email may contain a link to a uniquely generated website, which displays a “virtual” digital post-card, e.g., a graphic postcard consistent with the digital album theme, and presenting/streaming a 30-second preview version of the shared media. Additionally, multiple pieces of media may be shared, but the extent any media is shared may be controlled by the original content owner. For example, sharing a song or video may cause the postcard to stream the first 30-seconds, followed by an invitation to purchase a copy of the originating digital album. The receiving user may also be able to forward the postcard to other recipients, and each user may be able to add, remove, or otherwise modify the postcard before sending it off to other users. Users may be limited in only sending the V-Album content, and excluded from sending user content with this feature. Alternatively, users may be permitted to share all content, and have user created content uploaded for inclusion in the

### B. Centralized Application Resource Manager

Example embodiments of the present invention relate to an application resource manager for coordinating and optimizing a plurality of applications. In this example embodiment, each of the applications is based on an application framework. Each individual application may perform individual functions without the assistance of the application resource manager. However, the individual applications may interface with the application resource manager for various tasks, including resource limited tasks, such as message and/or data transfers with an external network.

The application resource manager may include a number of features designed to optimize the individual managed applications. First, many of the individual applications may require concurrent use of the limited bandwidth of the network connection of the system. Further, the several different needs for bandwidth may have a range of priorities, and may need to be organized accordingly. Additionally, the application resource manager may provide a central notification and control center. The application resource manager may further provide a subset of manager functions in a smaller, “slide-out” application display. Additionally, each independent managed application may require some form of post-download processing. For example, an mp3 e-commerce site may need to watermark each mp3 for origin determinations. Some or all of this post-download processing may be performed by the application resource manager, instead of the individual application itself, which generally performs all of the application specific processing. The application resource manager may prioritize and organize an efficient use of processing resources, visual display resources, or any other limited resource shared among the several individual applications.

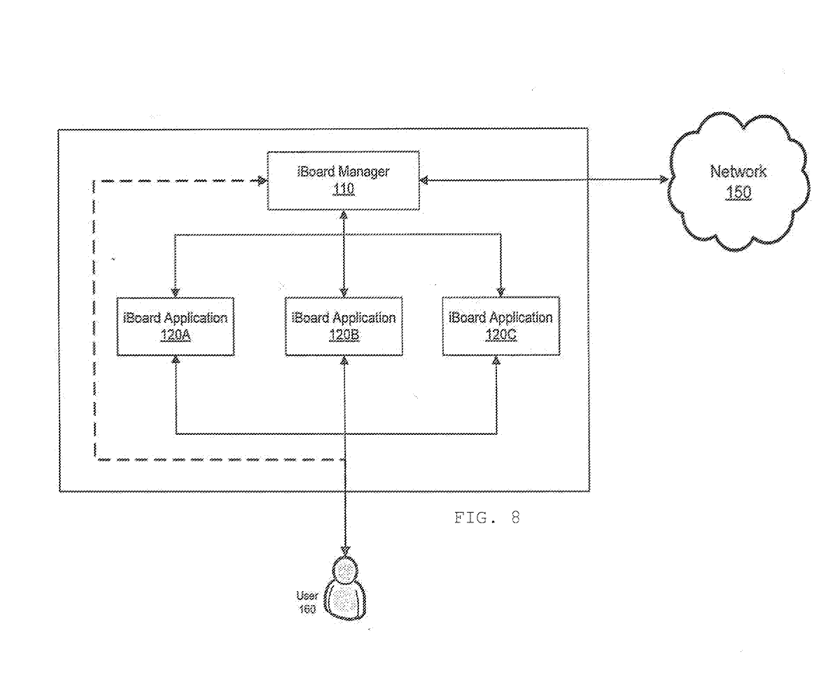

FIG. 8 illustrates one example of the relationships and structure of an example embodiment. The application resource manager 110 is connected to three independent applications. In one example embodiment, the applications are built on an iBoard™ framework. These individual applications (e.g., 120A to 120C) are accessed by the user 160. These individual applications may include any number of software applications, e.g., an mp3 player/downloader, a video streaming service, a game, a utility, etc. The applications 120 may be the primary interface for the user, but the user may also directly access the application resource manager 110. The application resource manager may be connected to the network I/O of the system, and facilitate communication with an outside network 150 (e.g., the Internet). The application resource manager may interface with the graphic display unit 160 and processor 170 to facilitate optimizing these shared resources among the several applications. With respect to the network I/O, each individual application 120 may have to send and receive all outside communication via the application resource manager, and may have no direct access to the network 150. The application resource manager and individual applications may run on a general or specific purpose computer or distributed system configured with any software or hardware. These types of computer systems, along with the variations of hardware and software used in them, are well known in the art, and any configuration suitable for the inventive aspects of this disclosure may be used.

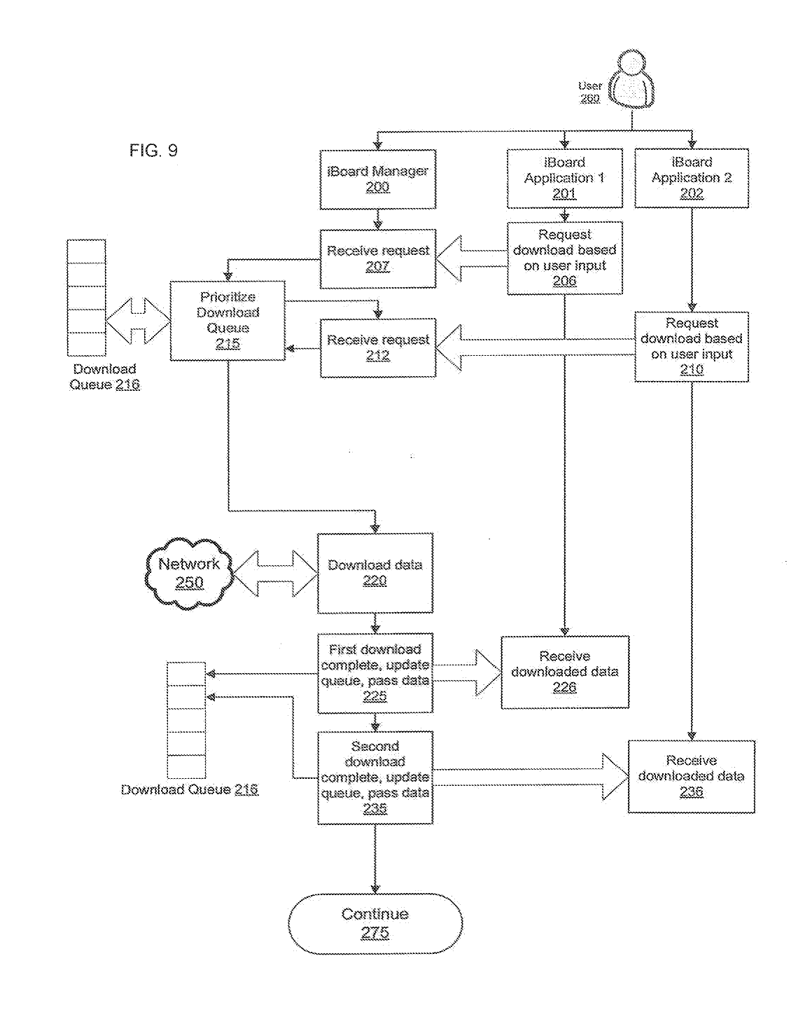

One example embodiment of the present invention includes the download prioritization procedure outlined in FIG. 9. Here, the concurrent execution of an example application resource manager 200 and two example individual applications 201/202 are illustrated. First, application 201 may receive user input from user 260 requesting data from the external network 250, e.g., a download. At 206, application 201 may send this request to the application resource manager, which may receive the request at 207. After each incoming request, the download may be placed in a queue and organized according to priority, e.g., at 215. Next, at 210, a second application 202 may request data from the external network 250, e.g. a download, based on user input. This request may be passed to the application resource manager and received at 212. Again, the request is placed in the download queue according to priority at 215. Once at least one data request has been queued, the example procedure may begin downloading data at 220, from the external network 250. The example procedure continues downloading data until a request is complete. For example, at 225, the first download may have finished. The example method will pass that download (or a pointer to the download) to the requesting application at 226. The application resource manager also updates the download queue 216 to remove the associated entry. At 235, the second download request may finish, be passed to the requesting application at 236, and be removed from the download queue. At 275, the example procedure may repeat until terminated.

The example procedure of FIG. 9 is shown with a concurrent, but linear progression. This figure is for illustrative purposes, and it will be appreciated that a multi-threaded concurrent implementation would be an advantageous embodiment. For example, a first thread of the application resource manager application may continuously be listening for incoming requests from associated individual applications (e.g., download requests). When at least one request is present in the queue, the application resource manager may continuously download data according to the queue priority, while the first thread is concurrently listening and/or receiving additional download requests. Further, the downloading process for other requests does not need to be halted when a request completes, but may concurrently continue while the download is passed off to the post-processor or requesting application (e.g., 201 or 202). Multi-threaded concurrent execution is well known in the art and may be implemented in any number of ways. Examples may include multi-processor systems, multi-core processors, simulated concurrence with time interrupt processing, etc. Example embodiments may include a number of other operations that may require concurrent execution, e.g., as discussed with regard to FIG. 11.

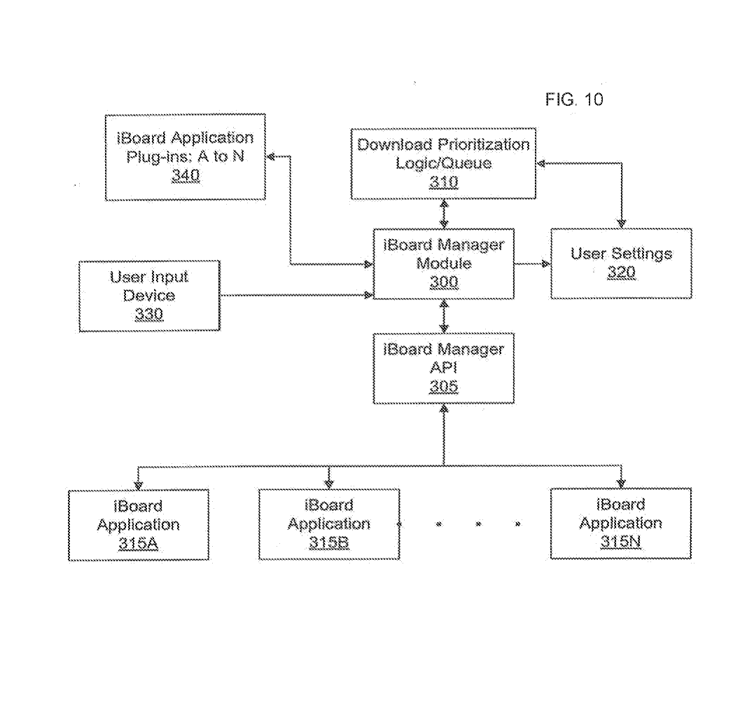

FIG. 10 illustrates an example embodiment of an example device configured to perform the application resource manager functions. This example device includes one or more user input devices 330. The example device includes one or more user output devices 335. Other conventional device peripherals may also be connected to the central application manager module 300, to facilitate the inventive aspects of the example device. For example, a device memory may be included where user settings 320 are stored based on user input from device(s) 330.

The memory may also store the active or stored download queue, and the prioritization logic 310. The prioritization logic may incorporate a number of techniques to optimize bandwidth performance and user preferences. In the example embodiment illustrated in FIG. 10, the example device may store user preferences in the user settings 320, related to the priorities of the user. For example, a user may specify that the background downloads from a video rental service have a certain priority over the background downloads of an mp3 market service. Additional prioritizations may be based on conventional priority schemes (e.g., real-time data prioritized over asynchronous data), or conventional priority structures (e.g., FIFO). Additionally, the prioritized queue may be established or modified based in part on direct or indirect user input. For example, a user of a file download application may be provided the option of “add to queue” and additionally provided the option of “add to top of queue.” In this case, the individual application will not only pass the download request to the application manager, but also (or as part of the request,) pass a message indicating a user preference for top priority. Priority may also be adjusted by direct user input at the application resource manager user interface. Different example embodiments may implement different prioritization schemes using a mixture of user preferences and conventional optimization schemes.

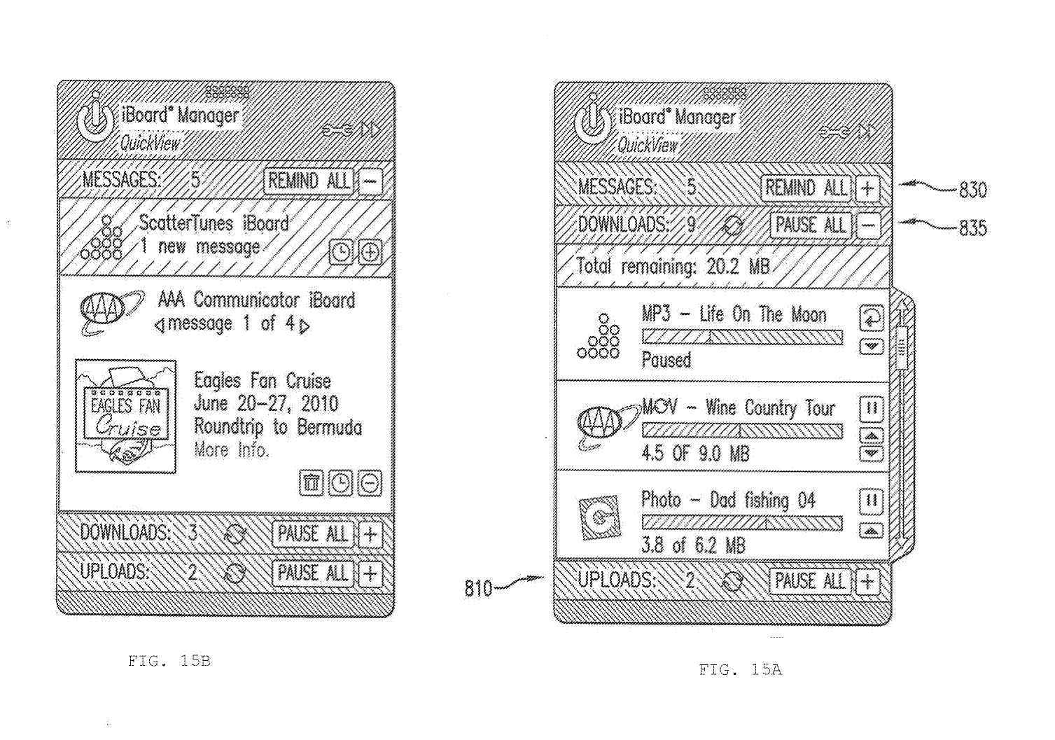

The memory may also store the active or stored message queue. Each individual application 315 may generate a number of system messages and user messages, e.g. an email, instant message, micro-blog update, or system message such as “download complete.” The messages may be organized and prioritized to conserve limited visual space in the system's visual output device, e.g. a monitor as output device 335. FIG. 15A may illustrate an embodiment of the quick-view slide-out application presenting a prioritization of messages, combined from the several individual applications 315. The user may be able to adjust these logic rules in the user settings 320. Users may indicate priorities of messages, or disable certain messages (e.g., download complete messages).

Further, the Application Resource Manager Module 300 may execute on a processor, e.g. an electronic hardware processor, and include execution scheduling logic 350. The application resource manager 300 may use a mix of default, hardcoded, and user settings to schedule and prioritize executable tasks on a shared resource processor, such that the several individual applications 315 may be optimized according to user preferences. The application resource manager module 300 may execute on a general purpose processor that may include pipeline optimization and other execution scheduling optimizations. The execution scheduling logic/queue 350 may operate on a higher level, prioritizing the several individual applications 315 according to user preferences, and interface with any built in general purpose processor scheduler for low level optimizations. Alternatively, example embodiments may improve or replace any hardware optimizers and perform execution scheduling and optimization at all levels.

In addition to being fully customizable by user preference, default prioritizations may follow a formula. The formula may also be customizable by the user and/or developers, and different implementations of example embodiments may use different formulas. The formula may be based on one or more factors. Each factor may be referred to as a component score, and the formula result may provide a prioritization based on these component scores (e.g., a prioritization score). One example formula may be provided in the illustrative context of a download queue (e.g., 310), and the same or similar prioritization formula may be applied to an execution scheduler, a message prioritization scheme, or any other system resource prioritize. For example, the formula may be a summation function of several component scores, including for example, an application score (e.g., associated with the originating application), a request score (e.g., assigned by the application to all requests coming from the application), a context score (e.g., time of day, current activity level of the computer, etc.), a user specification score (e.g., user indicated a desire for immediate downloading of a particular request), and any other component score. The sum of these may yield a final prioritization score, and the download queue may be organized by prioritization score. This is just one example embodiment; a prioritization could be based on any number of formula functions, any number of component factors, or any number of other priority schemes.

As mentioned, download prioritization (e.g., the prioritization score) may be based on an application score, where each individual application is given an initial priority score, which may be associated with downloads originating from that application. For example, business applications may have a higher priority score than entertainment applications. The user may be allowed to modify the application score associated with one or more individual applications. Each individual application may also assign a request score to each download request. The central prioritization formula may then allow for a mix of prioritizations among the individual applications. For example, in one embodiment, requests from a higher priority application may download according to the request level prioritization, and requests from a lower priority application may download only when no further requests exist from the higher priority application. Another embodiment may allow for high priority requests from a low priority application to download before low priority requests of a high priority application or low/medium priority requests of a medium priority application.

Additionally, request types may have an associated score, such that software updates may have a greater priority than file downloads, but a lower priority than business related requests. Additionally, prioritizations may be adjusted based on context, e.g., time of day. For example, a business related request (e.g., a request from a business application) may have a higher context score between 9 a.m. and 5 p.m. In this way, business requests may take priority during working hours, and other tasks (e.g., software updates) may take priority during other time periods. Preferred download time slots may be associated with other request types, and each individual application may have a default preferred time slot. These time slots may overlap, as the context score (e.g., time) may be one of many scores used to prioritize the various requests.

Each prioritization feature may be fully customizable to the user, or may be locked by the developer. Example customization options may include the ability to adjust an application score associated with an individual application. The user may be able to customize the maximum number of simultaneous downloads (e.g., one at a time or up to four at a time). The user may be able to customize the maximum bandwidth usage, e.g., the total upload rate and/or total download rate. Additionally, the user may be able to adjust the bandwidth usage for individual requests, for individual request types, or for individual applications. For example, a user may be able to specify a total download bandwidth of a thousand kilobytes a second, with the requests of any single application consuming less than twenty kilobytes a second, with no single request consuming more than ten kilobytes a second, except for a particular application and/or a particular request type, which may have different particular limits set by the user. The user may also be provided control functions for the queue, such as the ability to pause a download (whether in progress or not), pause all downloads, resume a download, or resume all downloads. The user may also be able to rearrange the queue, which may adjust a user priority score, as one of several scores used to organize the prioritization queue (e.g., as discussed above).

The application resource manager module 300 may include an Application Programming Interface (API) 305, which may be used to interface with the several individual applications 315A to 315N. This interface will be discussed further with regard to FIG. 11. Associated with the several individual applications 315, may be an application plug-in set 340. The application resource manager may have a plug-in from each of the individual applications associated with it. These plug-ins may be installed in the application resource manager system when the associated individual application is first connected to the application resource manager, e.g., as illustrated in FIG. 11. The plug-in may enable any number of advantageous features, and may provide the application resource manager 300 with a subset of the features associated with the individual application. For example, many of the individual applications 315 may require processing after a download completes. For example, many mp3 vendors require a digital watermark to be added to the mp3 to determine the origin of the file (discussed above). This processing would normally occur in the calling application. However, since the application resource manager may continue to run in the background, facilitating the queued downloads, a download may complete after the calling application has already been shut down. In this case, the application resource manager, using the associated plug-in, may perform the necessary post-download processing for the calling application. In some example embodiments of the present invention, this feature may be critical for both technological and non-technological reasons. For example, distribution rights given by original content owners to a distribution service, may require immediate processing of certain content, and may not allow that content to reside on the system in native form while waiting for the calling application to be restarted. Thus, in addition to providing a greater amount of flexibility and optimization, the associated plug-ins may afford additional compliance strategies for application developers.

FIG. 11 illustrates the initial inter-process communication (IPC) between the application resource manager 400 and individual applications 415. The application resource manager may include a permanent listening port 410, which may be the same for every application resource manager, e.g., the manager of a first system and the manager of a second, independent system. This port may remain open while the application resource manager is running, continuously listening for new connections. Each individual application may be pre-programmed with this known and universal listening port. In the example embodiment of the present invention, each system has only one application resource manager; thus there is no potential for conflict and the listener port may have a universally known address. In other embodiments, the listening port may be optionally set by the user.

When a new individual application is installed, a unique ID associated with the application may be transmitted to the application resource manager listener port 410 (e.g., as illustrated in step 1 of FIG. 11). The unique application ID 425A may contain the address of the communication port of the sending application (e.g., 420A). Upon receiving the unique ID 425A with the address of the application communication port 420A, the application resource manager 400 may generate a new, dedicated communication port 410A, for the new individual application. The application resource manager, using the unique ID 425A, may return the address of the newly created communication port, e.g., 430A. At this point, the application resource manager knows the address of the connecting application communication port 420A, and the individual application 415A knows the address of the port that was created and dedicated to that application 410A. IPC may now proceed between the APIs of the two programs, e.g., as illustrated in step 3.

As mentioned, the “permanent” listener port 410 is continually listening for new connections. Step 4 illustrates a second individual application 415B coming online, and sending its unique application ID 425B to the listener port 410. The application resource manager may create a new communication port 410B, and send the ID for that port 430B back to the second application communication port 410B. During the establishment of the second connection, the first application, having been moved to a dedicated communication port, may continue API communication with the application resource manager. In step 6, both installed individual applications are operating and communicating with the application resource manager, and the example procedure may continue the process for newly identified applications.

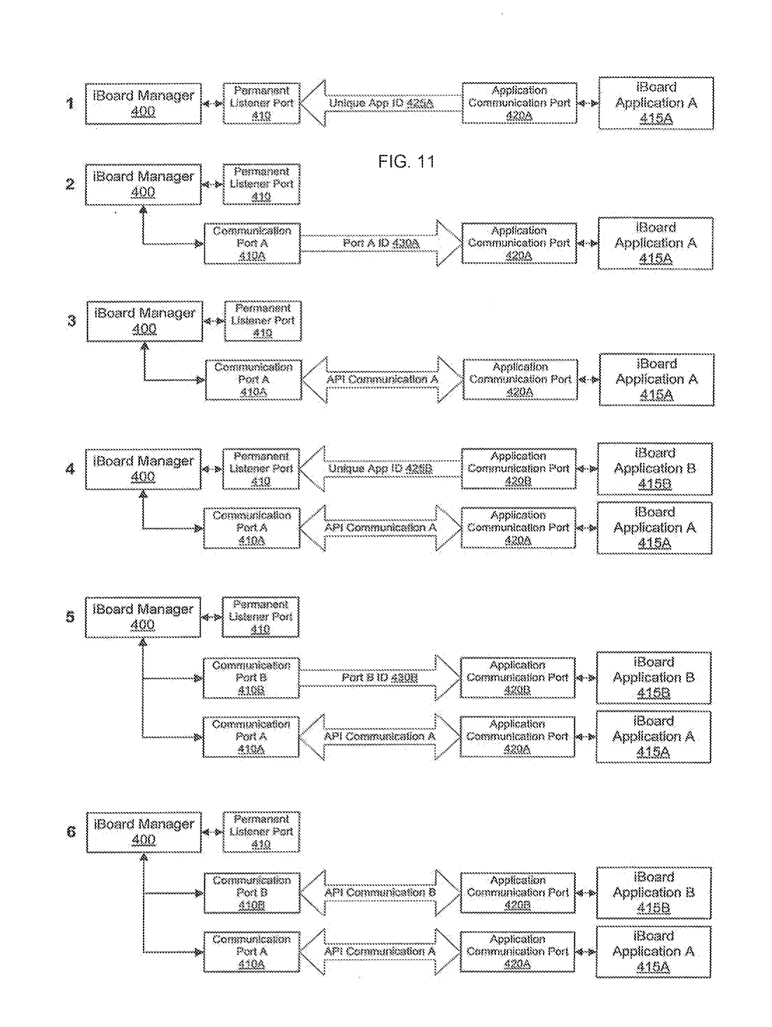

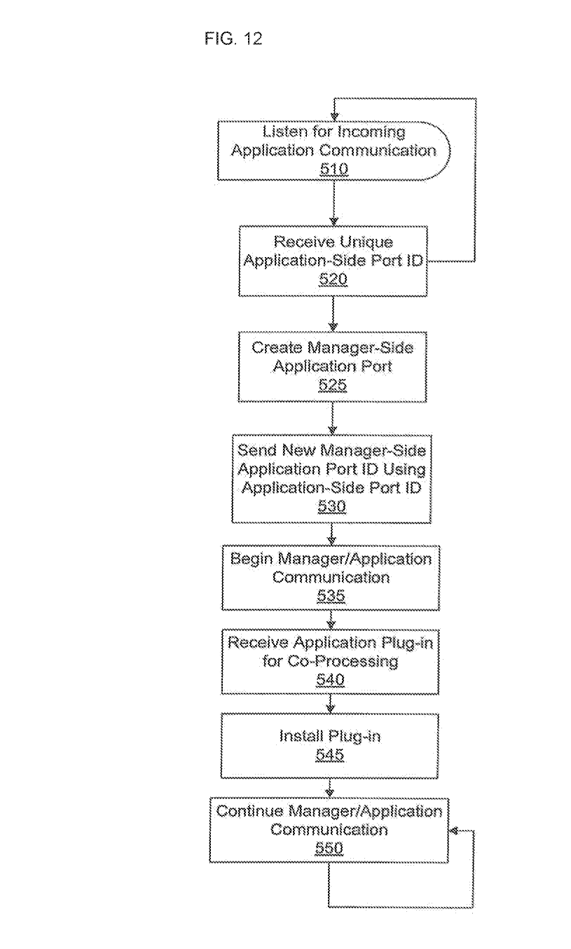

FIG. 12 illustrates an example procedure according to an example embodiment of the, present invention. At 510 the example procedure may wait for a new incoming application communication. Once received, the example procedure may return to listening for more incoming connections at 510, while also progressing to establish a link with the first application. At 525, the application resource manager may create a new manager-side application port dedicated to the connecting application. At 530, the application resource manager may send the new manager-side application port ID using the previously received application-side port ID. At 535, the example procedure may begin ongoing communication between the application resource manager and individual application. One of the first communications with a newly established application may be to receive a plug-in from the application. As previously discussed, the plug-in may contain a subset of application features. Specifically, the subset may include, for example, essential post-download processing operations that may perform required or performance optimization functions in the event the application is no longer online. In one embodiment, in the event that the application is still online when the download completes, the individual application may perform the post download processing itself. At 545, the application resource manager may install the plug-in. The initial connecting session may include any number of other initializing tasks, but once complete, at 550, the example procedure may begin continuous communication between the application resource manager and connected application, as needed.

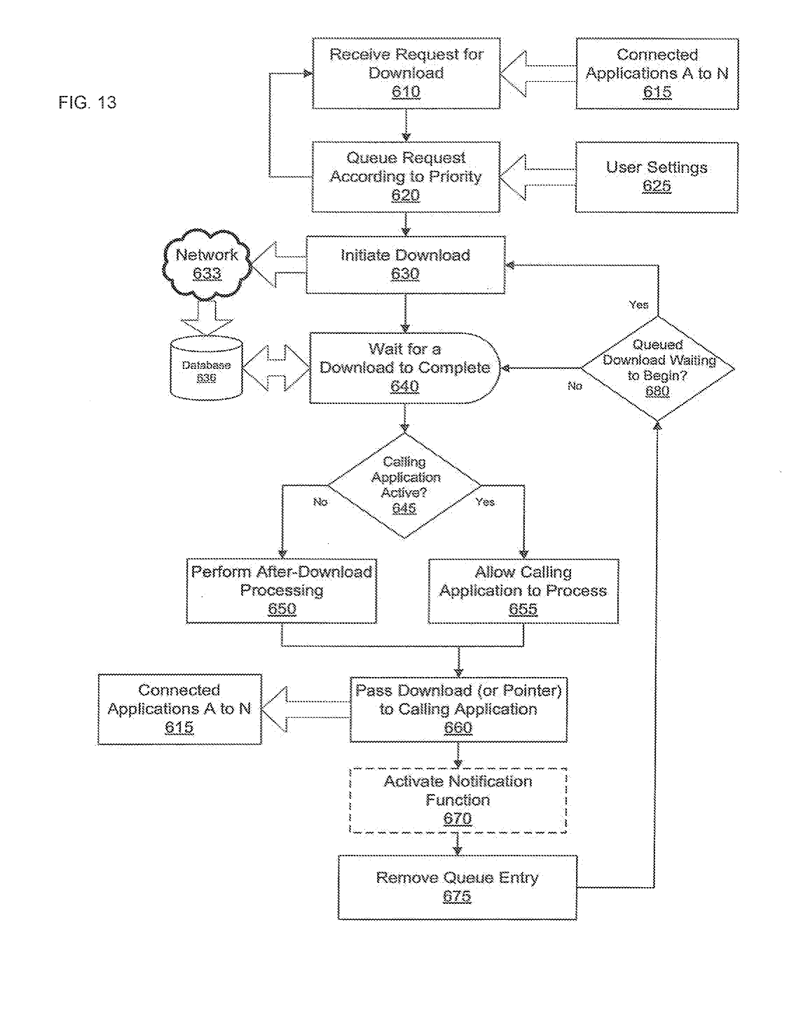

Another example procedure according to an example embodiment of the present invention is illustrated in FIG. 13. In this example procedure, individual applications A to N 615 have already been connected and installed, e.g., as illustrated in FIGS. 11 and 12. At 610, the application resource manager may receive a download request from a connected application via the associated application port. The application resource manager may queue the request according to the implemented priority scheme at 620, which may call upon user settings 625 to determine prioritization. The application resource manager program may continue this aspect of the procedure, receiving and queuing download requests. Concurrently with the receiving/queuing operations, at 630, when there are download requests in the queue, the application resource manager may initiate a download from an external network 633. At 640, when the optimum number of downloads are already underway, the example procedure may wait for one of the downloads to complete. Upon completion, the download may require post-download processing. This processing is typically performed by the calling individual application, but may be performed by the previously discussed plug-in. Thus, at 645, the example procedure may check to determine if the calling application is still active. If it is, the example procedure may allow the calling application to handle the post-download processing at 655. However, if the calling application has been shut-down, at 650, the application resource manager, executing the example procedure illustrated in FIG. 6, may perform the post-download processing.

Once the post-processing has been completed, the application resource manager may pass the download or a pointer to the download to the calling application at 660. If the calling application is not online, e.g., at 650, then the completion notification is stored for delivery upon reactivation of the calling application, e.g., at 652. Step 660 may alternatively be performed prior to 655, in addition to being performed subsequent to 652. In one example embodiment, the application resource manager, via the dedicated communication link, may communicate the download information via IPC, e.g., passing a pointer to the completed download to the calling application. Optionally, or upon a download that is configured to issue an alert, at 670, the example procedure may activate a notification function that may alert the user a download has completed. This could include any number of things, including: a system sound, a graphic message, sending an email, sending a text message, or providing an alert within the application resource manager user interface. At 675, the example procedure will remove the completed request from the download queue. Finally, the example procedure may cycle back at 680 to determine if further downloads are waiting to begin. If they are not, the example procedure may wait for any ongoing downloads to complete at 640. If there are pending downloads, the example procedure may initiate the next highest priority request in the queue, at 630.

As illustrated, example embodiments of the application resource manager may continuously connect new individual applications and install associated plug-ins received from those applications. The example embodiment may continuously receive download, update, message and/or any other request requiring data transfers with an outside network from connected applications. The example embodiment may prioritize and queue the requests, and facilitate the optimization of satisfying those prioritized requests. The example embodiment may post-process completed downloads, provide notifications, and pass the data to the requesting application for further use. Finally, the example embodiment may concurrently and continuously perform these operations, in addition to other tasks, to provide a performance optimized user experience.

FIG. 14A illustrates an example user interface (UI) according to an example embodiment of the present invention. The example UI may have several feature sets, e.g., iBoards, downloads, uploads, messages, and support. The example display of FIG. 14A illustrates the “iBoards” feature as a collection of the installed individual applications for the user to select. A fixed number of launch icons may be visible, and this number may be customizable in user settings. Further, navigation buttons may be present for rotating the set of launch icons that are visible and available for selection. As was previously discussed, each of these applications may call for data from an outside network (e.g., the Internet), and the prioritized and optimized queue of downloads for each application may be viewed under the “download” feature. An example of this view is illustrated in FIG. 14B. Relevant information may be presented about each download with graphics and/or text. For example, date/time queued, calling application, file name, file type, file size, download start, percent complete, estimated completion time, currently elapsed download time, total download time for finished items, prioritization level, command links to change prioritization levels, an explanation of why an entry has a certain priority, and any other relevant information or function link. The upload interface may be similar to the download interface, but with traffic in the opposite direction. Some applications may be upload intensive, such as system back up applications, photo sharing and online album applications, etc. Additionally, since most consumer Internet connections have an upload bandwidth that is significantly more restrictive than the download bandwidth of the same connection, mere messages, simple attachments, and update requests may cause a backlog of uploads requiring optimization.

The download and upload functions may also contain global functions, such as “pause all downloads,” “pause all uploads,” or “pause all transfers.” Additionally, global functions such as rescheduling, resuming, canceling, deleting, or reprioritizing the uploads, downloads, or transfers may be provided as user functions. Additionally, a subset of these functions may be provided in a smaller “pop out” UI. This smaller control interface may be designed to be less intrusive on the output display area, to more readily be used in conjunction with other applications on the device. One example embodiment of this smaller interface is illustrated in FIG. 15A and FIG. 15B. This example embodiment uses a “stack” of key features and functions. FIG. 15A illustrates an example expansion of the “Downloads” function, while FIG. 8B illustrates an example expansion of the “Messages” function. For example, at 810, the total number of current uploads is displayed with the function to “pause all” or expand this collapsed section to display more information, e.g., an itemized list of the uploads. Element 830 shows an expanded section. This section shows the pending messages with the functions of “remind all” and a “-” to collapse the section. Within the expanded section 830, a set of new messages for each active individual application is listed. In this example embodiment, collapsed and expanded sections are illustrated, but even the expanded sections are still a subset of the larger interfaces illustrated in FIGS. 14A and 14B. For example, the “Virtual Album iBoard” element 835, shows only one new message at a time, with navigation arrows to move to other new messages. This is only one illustrative example, and other implementations may include more or less information in the expanded view. The messages may also include function links, e.g., discard the message, send a reminder, and collapse the subsection.

The amount of information displayed on the smaller interface may be customized by user settings. For example, when a new download completes, the smaller interface may temporarily expand to display the message section for that application. Alternatively, the smaller interface may expand the entire message section, or just the specific message. The expansion may last until the user acknowledges the message, may collapse after a fixed period of time, or may collapse after a fixed period of time in which a condition occurs (e.g., input device activity to indicate the user is actively using the system). Alternatively, these features may be turned off, and expansion may only occur upon express user command, or such an arrangement may be set for certain types of messages (e.g., file completion), but not other types of messages (e.g., email). Further, messages on the smaller interface may include other functions within the messages, e.g., a download complete notification may include a function link to launch the individual application that originally requested the download.

It should be understood that there exist implementations of other variations and modifications of the invention and its various aspects, as may be readily apparent to those of ordinary skill in the art, and that the invention is not limited by specific embodiments described herein. Features and embodiments described above may be combined. It is therefore contemplated to cover any and all modifications, variations, combinations or equivalents that fall within the scope of the basic underlying principals disclosed and claimed herein.

What is claimed is:

1. A computer implementing a plurality of applications within an application framework, the computer including non-transitory computer readable media, having stored thereon, computer executable process steps operable to control the computer to implement the plurality of computer applications, the plurality of applications including at least a digital media player application, a download manager application, and a third computer application, the download manager application coordinating and optimizing downloading to the digital media player application and the third computer applications, the download manager application performing steps including
receiving from the digital media player application a first download request, the first download request being based on user input received by the digital media player application;
receiving from the third computer application a second download request, the second download request being based on user input received by the third computer application, wherein the digital media player application and the third computer applications are independent of each other; prioritizing the first download request and the second download request, according to at least user priority input; downloading data associated with the download requests, according to the prioritization; upon completion of a data download, passing information regarding the downloaded data to whichever application passed the associated request to the application manager; upon completion of a data download, removing the completed download from the prioritization, and for all remaining data download requests: downloading data associated with the remaining data download requests, according to the prioritization.

2. The framework of claim 1, further comprising receiving application updates from an update server and passing the updates along to whichever application of a plurality of applications indicated by a particular update.

3. The framework of claim 2, wherein a particular received application update was requested after receiving a message from a particular application requesting the particular update.

4. The framework of claim 1, further comprising receiving from one of the plurality of applications, a plug-in, configured to perform a sub-set of functions associated with a particular application that provided the plug-in.

5. The framework of claim 4, further comprising upon completion of a download, modifying the download based on functions defined by the plug-in provided by an application that requested the completed download.

6. The framework of claim 5, further comprising first checking to see if the application that requested the completed download is running, and if running, passing the completed download to the application for modifying the download, in substitute to performing the modifying at the application manager.

7. The framework of claim 1, wherein the prioritizing is based on a priority score derived from a combination of default settings, stored user settings, and other user input, including at least one of: an origination application, a request type, and a request context.

8. The framework of claim 1, wherein the first download request comprises a request to download a package of digital media as a single file, the package including a set of media titles and a set of other digital media related to one or more of the media titles, wherein the package is configured to be executed by the digital media player with digital media presentation functions configured to present the set of media titles, the set of other digital media, and each digital media file included in the package.

9. Non-transitory computer readable media, having stored thereon, computer executable process steps operable to control a computer to execute a plurality of computer applications including at least a download manager application, a second computer application and a third computer application, the download manager application coordinating and optimizing downloading to the second and third computer applications, the download manager application performing steps including
receiving from the second computer application a first download request, the first download request being based on user input received by the second computer application;
receiving from the third computer application a second download request, the second download request being based on user input received by the third computer application, wherein the digital media player application and the third computer applications are independent of each other;
prioritizing the first download request and the second download request, according to at least user priority input; downloading data associated with the download requests, according to the prioritization; upon completion of a data download, passing information regarding the downloaded data to whichever application passed the associated request to the application manager; upon completion of a data download, removing the completed download from the prioritization, and for all remaining data download requests: downloading data associated with the remaining data download requests, according to the prioritization.

10. The non-transitory computer readable media of claim 9, wherein the second computer application is a digital media album player application, and wherein the first download request comprises a request to download a package of digital media, and further comprising non-transitory computer readable media having stored thereon computer executable process steps operable to a control a further computer to perform steps comprising
generating a set of media titles and a set of other digital media related to one or more of the media titles; electronically transmitting the set of media titles to the computer for presentation to a user of the computer; receiving input at the further computer from the user via the computer indicating for which media titles from the set of media titles the user would like to receive a corresponding digital media file; transmitting from the further computer to the computer the package of digital media for download, including each digital media file indicated by the user; and wherein the package is configured to be executed by an album player with digital media presentation functions configured to present the set of media titles, the set of other digital media, and each digital media file included in the package.

11. Non-transitory computer readable media, having stored thereon, computer executable process steps operable to control a computer to execute a plurality of computer applications including at least a download manager application, a second computer application and a third computer application, wherein the second and the third computer applications are independent of each other and of the download manager application, and wherein the second application, the third application, and the download manager application can be independently shut down and independently run, the download manager application coordinating and optimizing downloading to the second and third computer applications, the download manager application performing steps including
receiving from the second computer application executing on the computer a first download request, the first download request being based on user input received by the second computer application;
receiving from the third computer application executing on the computer a second download request, the second download request being based on user input received by the third computer application;
prioritizing the first download request and the second download request;
downloading data associated with the download requests from a network, according to the prioritization;
upon completion of a data download from the network, determining if whichever application that requested the download is running, and if running passing information regarding the downloaded data to said whichever application for application-specific post download processing, and if the said whichever application is not running, performing said application-specific post download processing; upon completion of a data download from the network, removing the completed download from the prioritization, and for all remaining data download requests: downloading data associated with the remaining data download requests, according to the prioritization.

12. The non-transitory computer readable media of claim 11, wherein the receiving, prioritizing, determining, and passing are performed for at least a third application and third download request.

13. The non-transitory computer readable media of claim 11, wherein the prioritization is based upon input received from a user.

14. The non-transitory computer readable media of claim 11, wherein the second computer application is a digital media album player application, and wherein the first download request comprises a request to download a package of digital media, and further comprising non-transitory computer readable media having stored thereon computer executable process steps operable to a control a further computer to perform steps comprising
generating a set of media titles and a set of other digital media related to one or more of the media titles; electronically transmitting the set of media titles to the computer for presentation to a user of the computer; receiving input at the further computer from the user via the computer indicating for which media titles from the set of media titles the user would like to receive a corresponding digital media file; transmitting from the further computer to the computer the package of digital media for download, including each digital media file indicated by the user; and wherein the package is configured to be executed by an album player with digital media presentation functions configured to present the set of media titles, the set of other digital media, and each digital media file included in the package.

15. The non-transitory computer readable media of claim 11, further comprising receiving application updates from an update server and passing the updates along to whichever application of a plurality of applications indicated by a particular update.

16. The non-transitory computer readable media of claim 15, wherein a particular received application update was requested after receiving a message from a particular application requesting the particular update.

17. The non-transitory computer readable media of claim 11, further comprising receiving from a plurality of applications, a plug-in, configured to perform a sub-set of functions associated with a particular application that provided the plug-in.

18. The method of claim 7, wherein for each of the plurality of applications, the sub-set of functions associated with said particular application is said application-specific post download processing for said particular application, and further comprising, upon completion of a download, modifying the download based on functions defined by the plug-in provided by an application that requested the completed download.

19. The non-transitory computer readable media of claim 11, wherein the method includes providing a user interface to control aspects of a computer system upon which the method executes, the method further comprising: minimizing the user interface; and providing a reduced user interface including at least the following functions: functions to pause all uploads, downloads, or both, functions to display at least part of a newly received notification.

20. The non-transitory computer readable media of claim 11, wherein the prioritizing is based on a priority score derived from a combination of default settings, stored user settings, and other user input, including at least one of: an origination application, a request type, and a request context.
